(19) United States
(12) Patent Application Publication
(10) Pub. No.: US 2025/0044533 A1
(43) Pub. Date: Feb. 6, 2025

(54) TECHNOLOGIES FOR OPTICAL INTERPOSER MATING WITH PHOTONIC INTEGRATED CIRCUIT DIES

(71) Applicant: Intel Corporation, Santa Clara, CA (US)

(72) Inventors: Xavier F. Brun, Hillsboro, OR (US); Jonas G. Croissant, Maricopa, AZ (US)

(73) Assignee: Intel Corporation, Santa Clara, CA (US)

(21) Appl. No.: 18/362,308

(22) Filed: Jul. 31, 2023

(51) Int. Cl. G02B 6/42; G02B 6/43

(52) U.S. Cl. CPC G02B 6/4243; G02B 6/4212; G02B 6/4239; G02B 6/43

(57) ABSTRACT

In an illustrative embodiment, mechanical adhesive and a separate index-matching material are used as underfill between a photonic integrated circuit (PIC) die and an optical interposer. The index-matching material reduces coupling loss between waveguides of the PIC die and waveguides of the optical interposer, while the mechanical adhesive secures the optical interposer in place. The mechanical adhesive can be thermally cured, have a low coefficient of thermal expansion (CTE), have high viscosity, and have a relatively high optical transmission loss. The index-matching material can have low optical transmission loss, be UV cured, have a relatively high CTE, and have low viscosity. The combination of mechanical adhesive and index-matching material can improve ease of manufacture and yield. Additional features are disclosed, such as V-groove arrays in the optical interposer and the PIC die that have low stress and trenches and walls to control flow of the mechanical adhesive and/or index-matching material.

### BACKGROUND

Photonic integrated circuits (PICs) can be used for several applications, such as communications. Efficiently and cheaply aligning optics to couple light into and out of PICs can be a challenge. Approaches such as attachment of optical fiber arrays to PICS may be slow, incompatible with conventional semiconductor packaging processes, and can result in substantial yield and throughput issues.

### BRIEF DESCRIPTION OF THE DRAWINGS

FIG. 1 is a simplified drawing of one embodiment of a system with a photonic integrated circuit (PIC) die and an optical interposer.

FIG. 2 is a simplified drawing of the system of FIG. 1 without the optical interposer.

FIG. 3 is a simplified drawing of the optical interposer of FIG. 1.

FIG. 4 is a top-down view of the system of FIG. 1.

FIG. 5 is a top-down view of the system of FIG. 2.

FIG. 6 is a front view of the system of FIG. 2.

FIG. 7 is a cross-sectional view of the system of FIG. 2.

FIG. 8 is a cross-sectional view of the system of FIG. 2.

FIG. 9 is a cross-sectional view of the system of FIG. 2.

FIG. 10 is a cross-sectional view of the system of FIG. 4.

FIG. 11 is a top-down view of the system of FIG. 1.

FIG. 12 is a cross-sectional view of the system of FIG. 4.

FIG. 13 is a cross-sectional view of the system of FIG. 4.

FIG. 14 is a cross-sectional view of the mechanical adhesive of FIG. 10.

FIG. 15 is a cross-sectional view of the index-matching material of FIG. 10.

FIG. 16 is a cross-sectional view of the optical interposer of FIG. 3.

FIG. 17 is a cross-sectional view of the system of FIG. 4.

FIG. 18 is a simplified drawing of one embodiment of a system with a PIC die and an optical interposer.

FIG. 19 is a simplified drawing of one embodiment of a system with a PIC die, an optical interposer, and an optical plug.

FIG. 20 is a simplified flow diagram of at least one embodiment of a method for manufacturing a system including a PIC die and an optical interposer.

FIG. 21 is a simplified drawing of one embodiment of part of a system at one stage of the method of FIG. 20.

FIG. 22 is a simplified drawing of one embodiment of part of a system at one stage of the method of FIG. 20.

FIG. 23 is a simplified drawing of one embodiment of part of a system at one stage of the method of FIG. 20.

FIG. 24 is a top view of a wafer and dies that may be included in a microelectronic assembly, in accordance with any of the embodiments disclosed herein.

FIG. 25 is a cross-sectional side view of an integrated circuit device that may be included in a microelectronic assembly, in accordance with any of the embodiments disclosed herein.

FIGS. 26A-26D are perspective views of example planar, gate-all-around, and stacked gate-all-around transistors.

FIG. 27 is a cross-sectional side view of an integrated circuit device assembly that may include a microelectronic assembly, in accordance with any of the embodiments disclosed herein.

FIG. 28 is a block diagram of an example electrical device that may include a microelectronic assembly, in accordance with any of the embodiments disclosed herein.

### DETAILED DESCRIPTION

In various embodiments disclosed herein, an optical interposer is mated with a photonic integrated circuit (PIC) die. Several waveguides are defined in the optical interposer and the PIC die, and the optical interposer is mated such that the waveguides in the optical interposer are aligned to the waveguides in the PIC die, allowing for light to be coupled between the optical interposer and the PIC die. As described in more detail below, various features may be included in various embodiments that may improve performance, manufacturing yield, etc. For example, in some embodiments, the optical interposer is adhered to the PIC die using a mechanical adhesive, while an index-matching material is used to improve coupling between the PIC die and the optical interposer. The use of one material to provide index matching and one material to provide mechanical stability can provide several benefits, such as more flexible manufacturing options, increased performance, and increased yield, as described in more detail below.

Additionally or alternatively, in some embodiments, arrays of V-grooves on the PIC die and/or the optical interposer can be designed to improve performance. The V-grooves can be designed so that the peaks of one array of V-grooves interface with the valleys of the other array of V-grooves, rather than the V-grooves interfacing at the sides of the V-grooves. Such an approach can reduce or more evenly distribute stress, reducing the possibility of a component being damaged. Another feature that can be incorporated is a trench in the PIC die to prevent excess mechanical adhesive from leaking out onto a substrate, potentially resulting in a failure.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

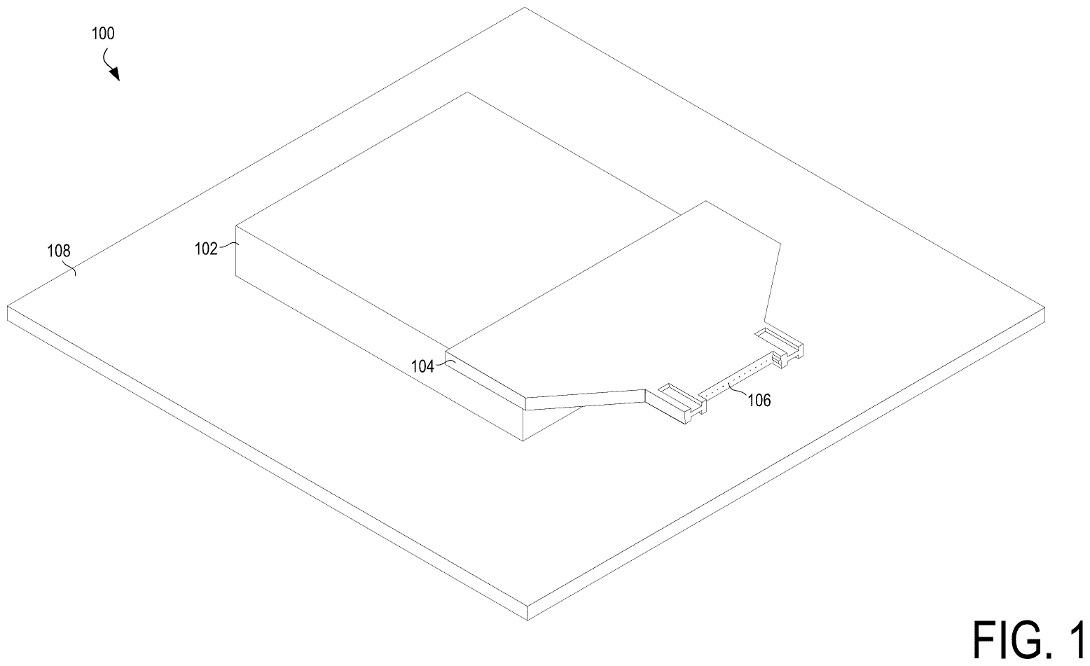

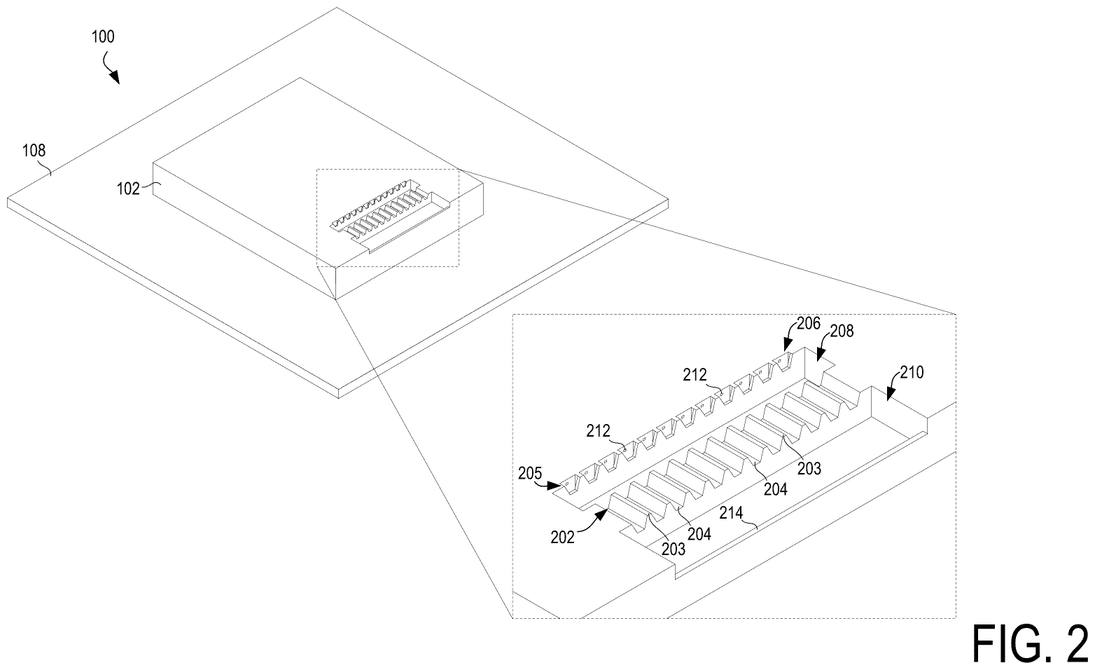

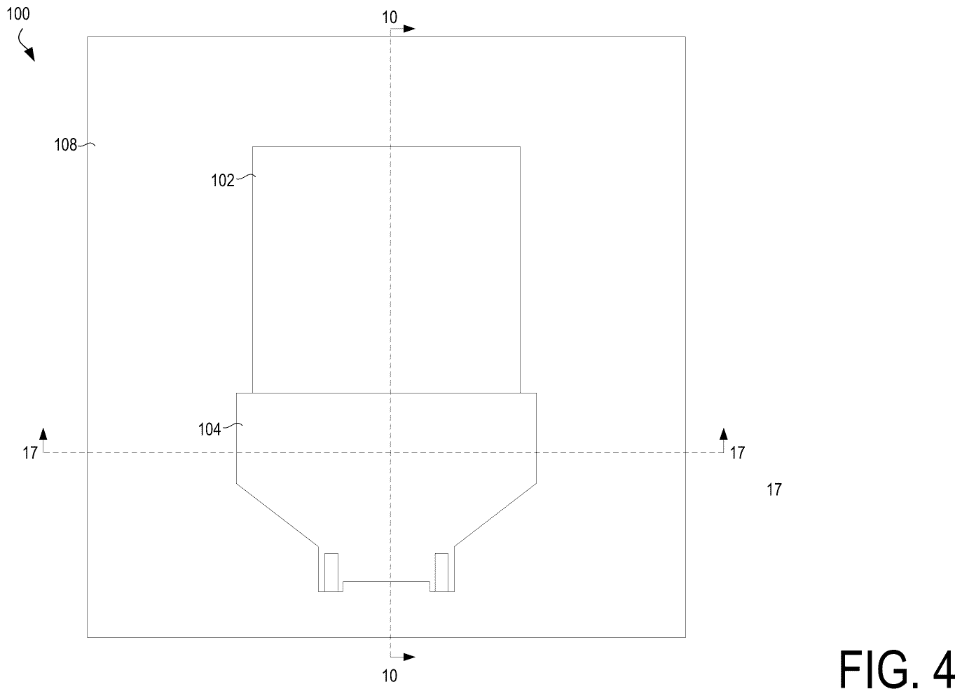

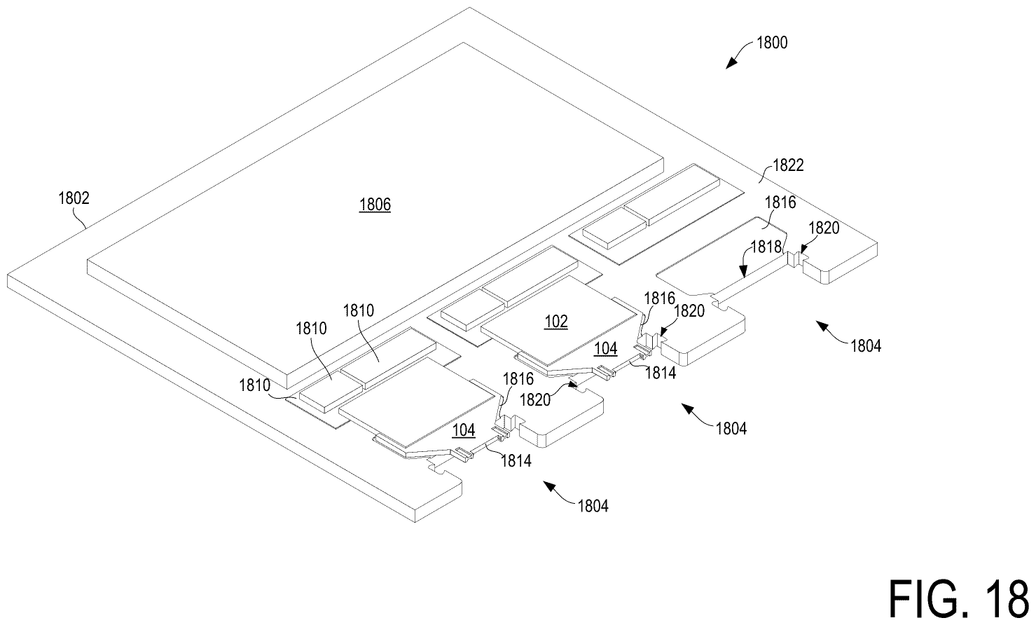

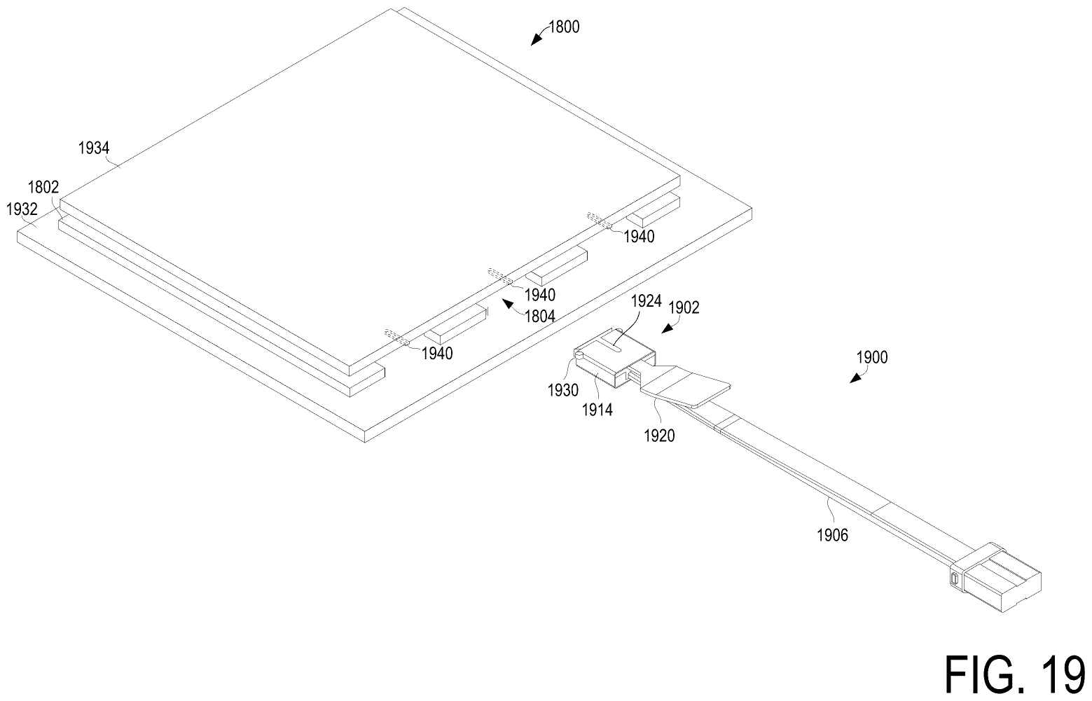

Referring now to FIG. 1, in one embodiment, a system includes a substrate 108, a photonic integrated circuit (PIC) die 102 mounted on the substrate 108, and an optical interposer 104 mated with the PIC die 102. The ends of one or more waveguides 106 are positioned at one end of the optical interposer 104. The waveguides 106 extend through the body of the optical interposer 104 to the other end of the optical interposer (see FIG. 4). The waveguides 106 are aligned to waveguides 212 defined in the PIC die 102 (see FIG. 2), allowing for light to be coupled between the optical interposer 104 and the PIC die 102. In use, an optical plug can mate with the optical interposer 104, as described below in more detail in regard to FIGS. 18 and 19.

The illustrative optical interposer 104 is silicon oxide glass. In other embodiments, the optical interposer 104 may be made of any suitable material that may be crystalline, non-crystalline, amorphous, etc., such as fused silicon, borosilicate, sapphire, yttrium aluminum garnet, etc. The optical interposer 104 may be, e.g., aluminosilicate glass, borosilicate glass, alumino-borosilicate glass, silica, fused silica. The optical interposer 104 may include one or more additives, such as Al₂O₃, B₂O₃, MgO, CaO, SrO, BaO, SnO₂, Na₂O, K₂O, SrO, P₂O₃, ZrO₂, Li₂O, Ti, and Zn. The optical interposer 104 may comprise silicon and oxygen, as well as any one or more of aluminum, boron, magnesium, calcium, barium, tin, sodium, potassium, strontium, phosphorus, zirconium, lithium, titanium, and zinc. The optical interposer 104 may include at least 20-40 percent silicon by weight, at least 20-40 percent oxygen by weight, and at least 5 percent aluminum by weight. For example, some embodiments of the optical interposer 104 may include, e.g., at least 20-23 percent silicon and at least 20-26 percent oxygen by weight. The optical interposer 104 may have any suitable length or width, such as 10-500 millimeters. The optical interposer 104 may have any suitable thickness, such as 0.2-5 millimeters. The optical interposer 104 may also be referred to as an optical coupler, a glass interposer, a glass coupler, etc.

The optical interposer 104 may route light between an optical plug and the PIC die 102 using waveguides defined in the optical interposer 104. The waveguides may be routed in any suitable manner, including in three dimensions, allowing for flexible layouts. The optical interposer 104 may include optical elements such as fan outs, splitters, couplers, combiners, filters, etc.

The PIC die 102 may be made of any suitable material, such as silicon. In the illustrative embodiment, waveguides 212 are defined in the PIC die 102 that interface with waveguides 106 defined in the optical interposer 104 to transfer light to or from the PIC die 102. In an illustrative embodiment, waveguides 212 in the PIC die 102 may be silicon waveguides embedded in silicon oxide cladding. The PIC die 102 may include any suitable number of waveguides 212, such as 1-1,024.

The PIC die 102 is configured to generate, detect, and/or manipulate light. The PIC die 102 may include active or passive optical elements such as splitters, couplers, filters, optical amplifiers, lasers, photodetectors, modulators, etc. The PIC die 102 may have electrical connections to a substrate and/or an EIC die, such as for power delivery, sending and receiving data, and/or the like.

The illustrative substrate 108 may be any suitable substrate, such as silicon, glass, ceramic, a circuit board, etc. In some embodiments, the substrate 108 is a circuit board made from any suitable material, such as ceramic, glass, and/or organic-based materials with fiberglass and resin, such as FR-4. The substrate 108 may have any suitable length or width, such as 10-500 millimeters. The substrate 108 may have any suitable thickness, such as 0.2-5 millimeters.

In an illustrative embodiment, the system 100 is at one stage of manufacturing an integrated circuit package that will include the PIC die 102 and the optical interposer 104. The PIC die 102 may be separated from the substrate 108 as part of packaging the integrated circuit package. One embodiment of an integrated circuit package including the PIC die 102 and optical interposer 104 at a different stage of manufacturing is described below in regard to FIGS. 18 and 19. The system 100 may include additional components not shown in FIG. 1 at any suitable stage of a manufacturing process.

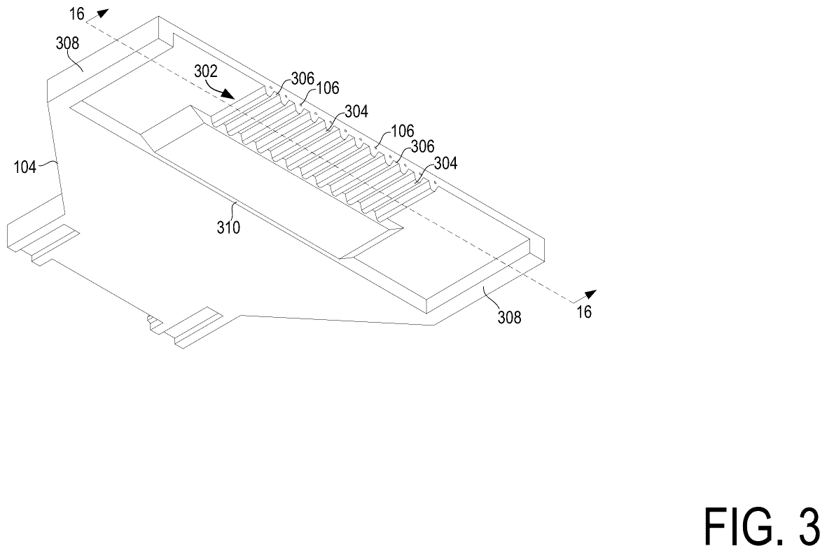

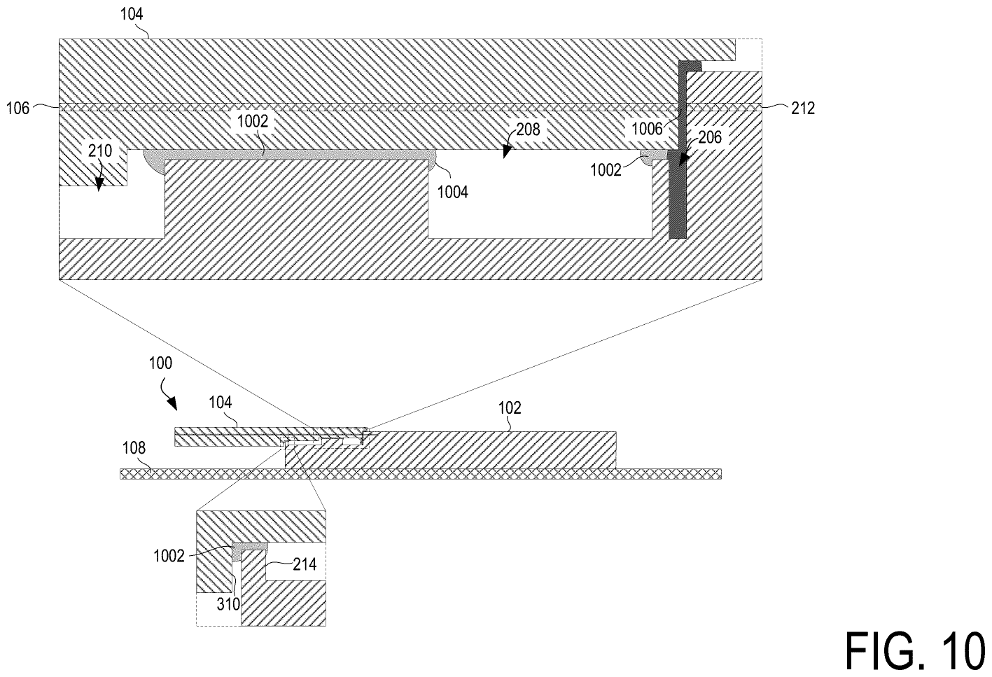

Referring now to FIG. 2, in one embodiment, the system 100 is shown without the optical interposer 104, showing a view of some of the structure for mating the optical interposer 104 with the PIC die 102. The PIC die 102 includes two V-groove arrays 202, 205 that mate with a corresponding V-groove array 302 in the optical interposer 104 (see FIG. 3). The V-groove arrays 202, 205 includes a series of alternating peaks 203 and valleys 204. In the illustrative embodiment, a trench 208 is defined between the V-groove arrays 202, 205, as shown in FIG. 2. A trench 206 is defined between the waveguides 212 and the end of each V-groove in the array 205. A trench 210 is defined between the V-groove array 202 and a wall 214. As described in more detail below in regard to FIGS. 10-13, the trenches 206, 208, 210 can facilitate placement of mechanical adhesive 1002 and index-matching material 1006. In the illustrative embodiment, the PIC die 102 includes trenches 206, 208, 210. In some embodiments, the PIC die 102 may include any suitable combination of the trenches 206, 208, 210.

In an illustrative embodiment, the V-groove arrays 202, 205 have a pitch of about 160 micrometers and a depth (i.e., vertical distance between the peaks 203 and the valleys 204) of about 110 microns. In other embodiments, the V-groove arrays 202, 205 may have any suitable pitch or depth, such as 30-500 micrometers.

In an illustrative embodiment, the V-groove arrays 202, 205, the trenches 206, 208, 210, the wall 214, etc., are etched from the substrate of the PIC die 102, such as by using 2D and 3D lithography. In other embodiments, some or all of the V-groove arrays 202, 205, the trenches 206, 208, 210, the wall 214, etc., may be formed from another material, such as a material grown on or adhered to the PIC die 102.

Referring now to FIG. 3, in one embodiment, the optical interposer 104 has a V-groove array 302 defined on a surface of the optical interposer 104. The V-groove array 302 includes alternating peaks 304 and valleys 306. When the optical interposer 104 is mated with the PIC die 102, the V-groove array 302 mates with the V-groove arrays 202, 205.

In an illustrative embodiment, the V-groove array 302 has a pitch of about 160 micrometers and a depth (i.e., vertical distance between the peaks 304 and the valleys 306) of about 90 microns. In other embodiments, the V-groove array 302 may have any suitable pitch or depth, such as 30-500 micrometers.

In an illustrative embodiment, the optical interposer 104 includes side walls 308 mated with the sides of the PIC die 104. The optical interposer 104 also includes a side wall 310 that mates with the outside of the wall 214 of the PIC die 102. As described in more detail below in regard to FIGS. 10-13, mechanical adhesive 1002 may be present at some or all of the interfaces between the side walls 308, 310 and the PIC die 102, improving mechanical attachment of the optical interposer 104 to the PIC die 102.

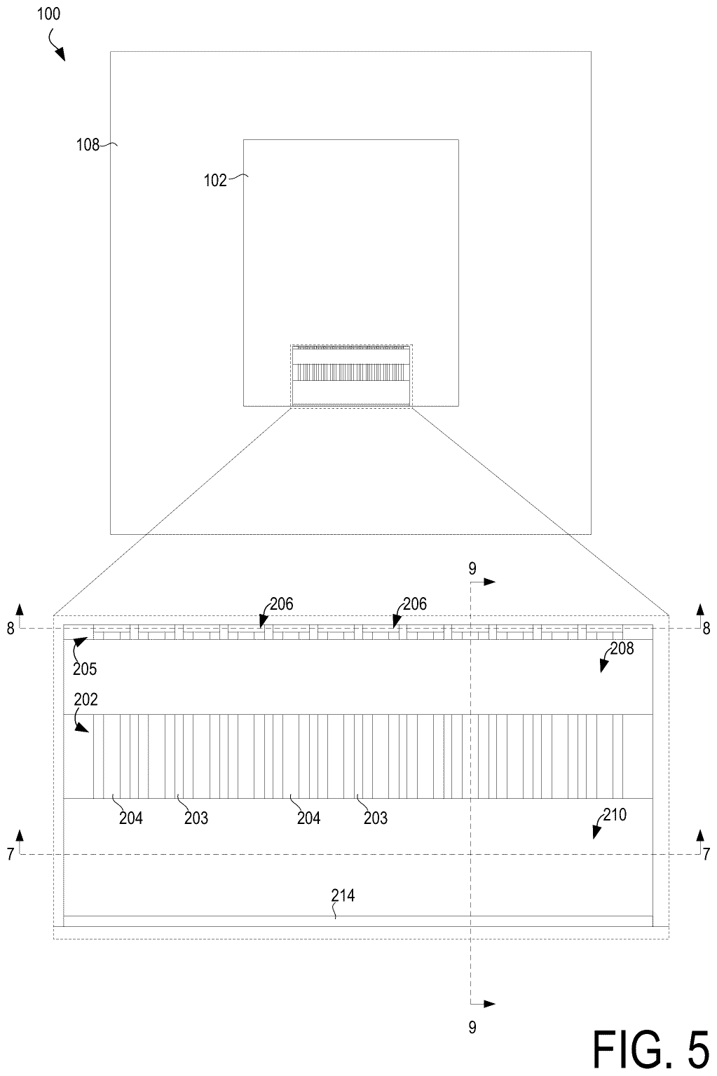

Referring now to FIGS. 4-9, various views of the system 100 are presented. FIG. 4 shows a top-down view of the system 100, including the PIC die 102 and the optical interposer 104. FIG. 5 shows a top-down view of the system 100 with the PIC die 102 and without the optical interposer 104. FIG. 5 shows the V-groove array 202, 205, the trenches 206, 208, 210, and the wall 214.

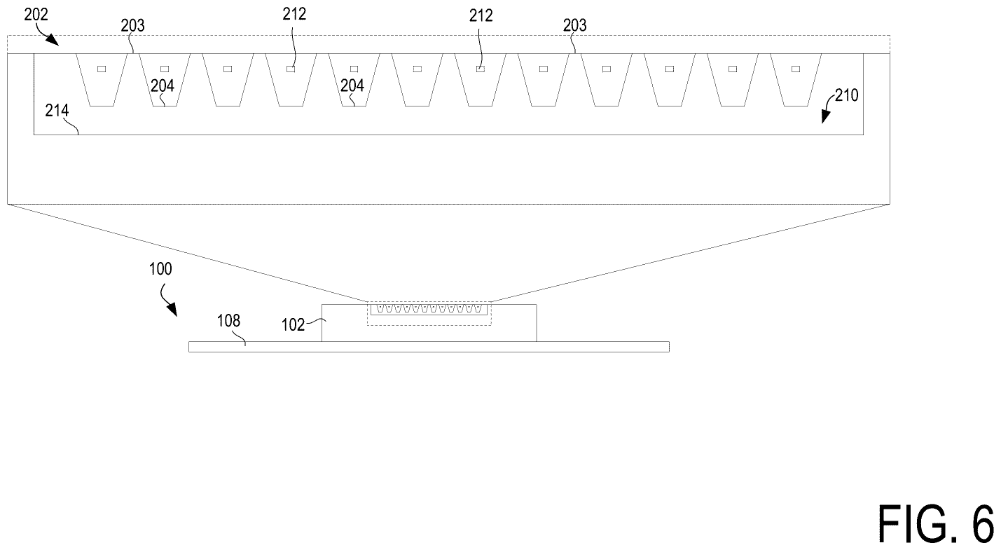

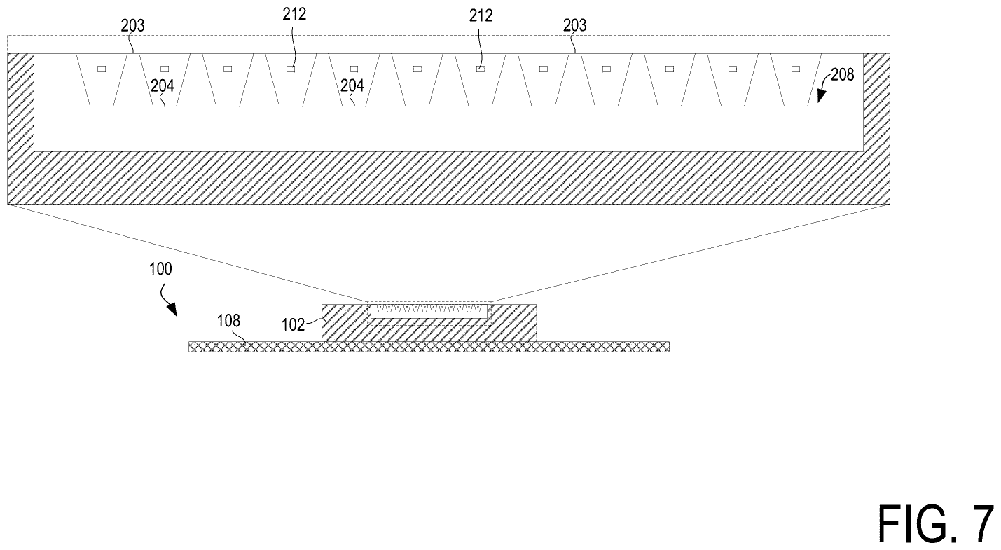

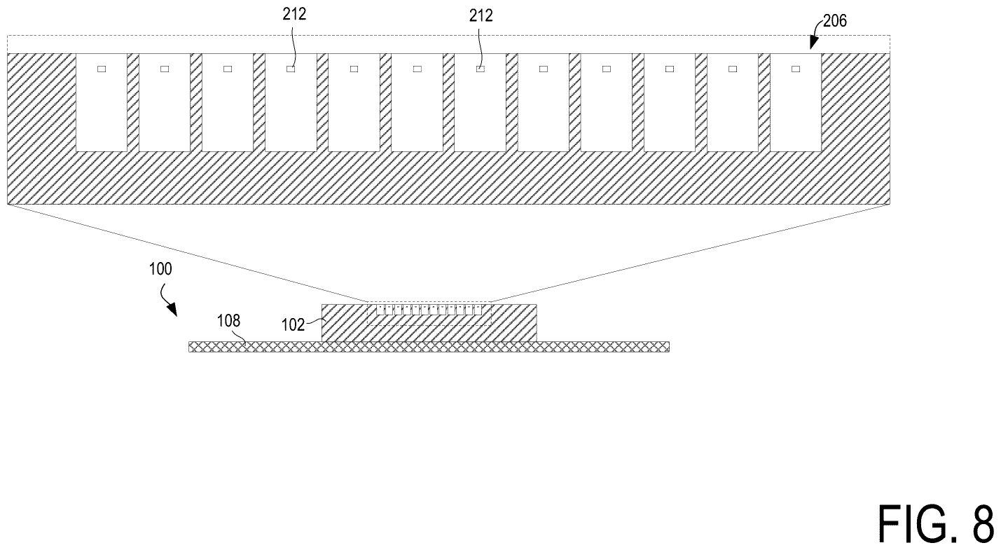

FIG. 6 shows a front view of the system 100 with the PIC die 102 and without the optical interposer 104. FIG. 6 shows the V-groove array 205 past the wall 214 and the trench 210. FIG. 7 shows a cross-sectional view of the system 100 with the PIC die 102 and without the optical interposer 104 from the same perspective as FIG. 6, taken at a cross-section through the trench 208. FIG. 8 shows a cross-sectional view of the system 100 with the PIC die 102 and without the optical interposer 104 from the same perspective as FIG. 6, taken at a cross-section through the trenches 206.

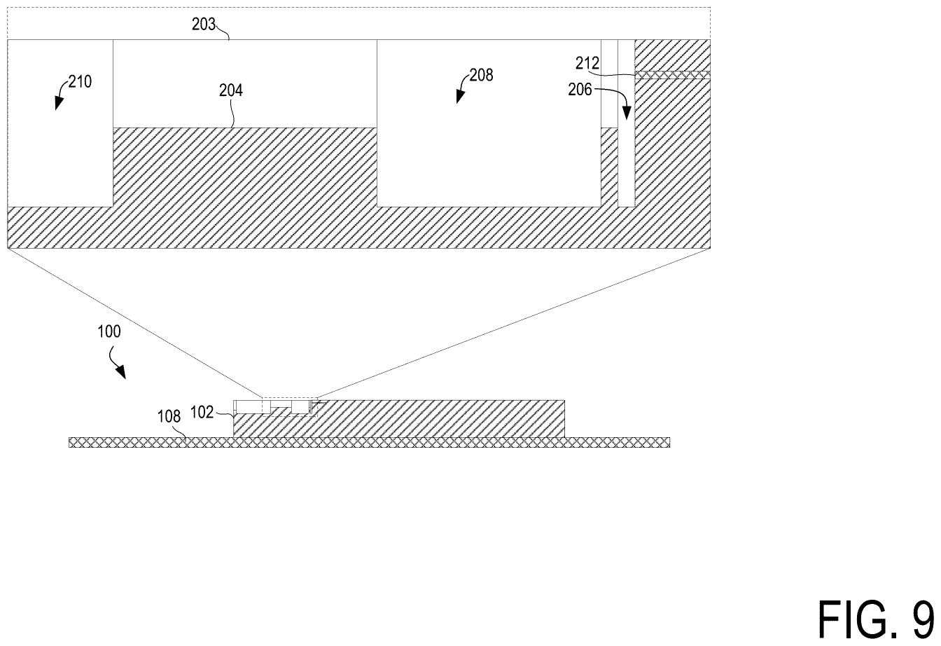

FIG. 9 shows a cross-sectional view of the system 100 with the PIC die 102 and without the optical interposer 104. The perspective of FIG. 9 is taken at a plane through one of the valleys 204 parallel to one of the V-grooves of the array 202. FIG. 9 shows the trenches 206, 208, 210.

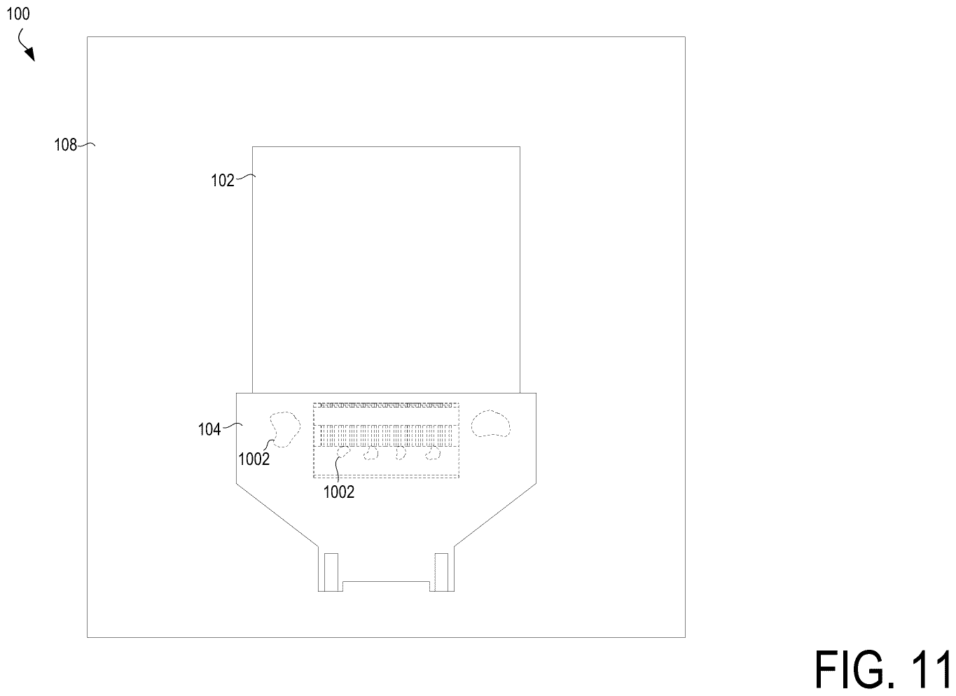

Referring now to FIGS. 10-11, in one embodiment, the system 100 includes mechanical adhesive 1002 and index-matching material 1006. The mechanical adhesive 1002 secures the optical interposer 104 in place relative to the PIC die 102, and the index-matching material improves coupling between the waveguides 106, 212 by reducing reflections at the ends of the waveguides 106, 212.

In an illustrative embodiment, the mechanical adhesive 1002 is placed between the V-groove arrays 202, 205 of the PIC die 102 and the V-groove array 302 of the optical interposer 104, as well as between the wall 214 and the optical interposer 104. As shown in FIG. 11, mechanical adhesive 1002 may also be placed between the wings of the optical interposer 104 and the PIC die 102, to the sides of the area where the waveguides 106 are. The trenches 206, 208, 210 allow space for the mechanical adhesive 1002 and/or the index-matching material 1006 to flow into, preventing the mechanical adhesive 1002 and/or the index-matching material 1006 from spreading to undesired locations. Additionally or alternatively, the wall 214 can prevent excess mechanical adhesive 1002 and/or excess index-matching material 1006 from flowing out of the trench 210, preventing excess material from leaking down the side of the PIC die 102. If, for example, excess mechanical adhesive 1002 flowed down the side of the PIC die 102 to the substrate 108, the PIC die 102 may not be able to be removed from the substrate 108 for further packaging, leading to a failure and lower yield.

In some embodiments, some flow into trenches 206, 208, 210, along side walls 308, 310, and/or along the wall 214 may be desirable, as it provides an additional surface for the mechanical adhesive 1002 to adhere to. This can allow for formation of fillets 1004, which can provide strong adhesion of the optical interposer 104 to the PIC die 102.

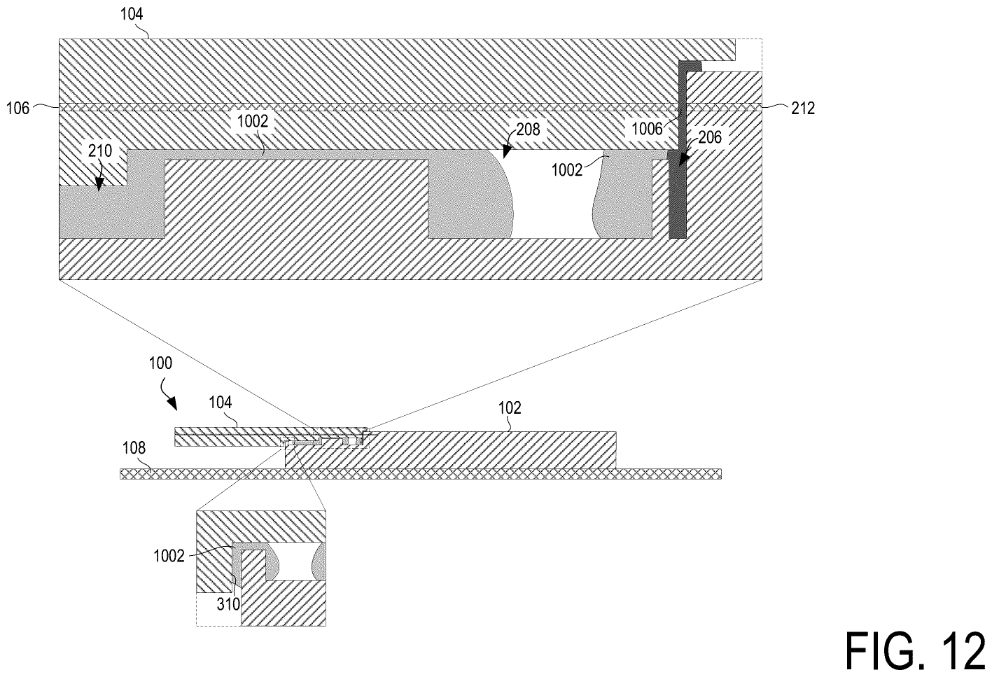

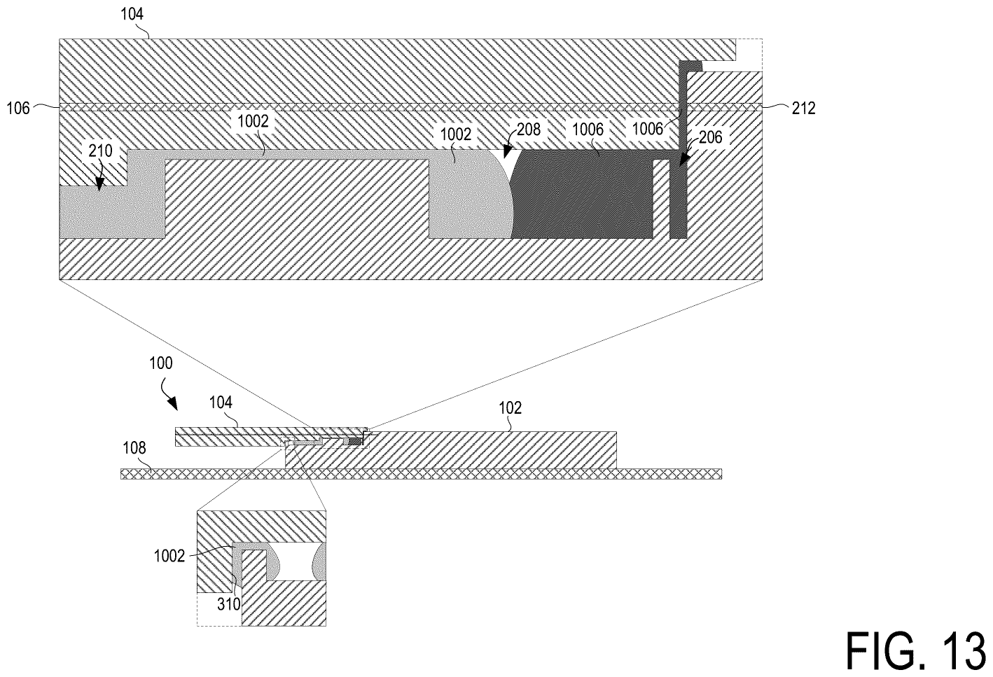

It should be appreciated that the trenches 206, 208, 210 allow for flexible distributions of various amounts of mechanical adhesive 1002 and/or index-matching material 1006. For example, relatively small amounts may be used, as shown in FIG. 10, with no or small amounts flowing into the trenches 206, 208, 210. In another example, more may be used, as shown in FIG. 12, with more mechanical adhesive 1002 flowing into the trenches 208, 210. In yet another example, more index-matching material 1006 may be used, as shown in FIG. 13, with the index-matching material 1006 flowing into the trench 208 as well as the trenches 206.

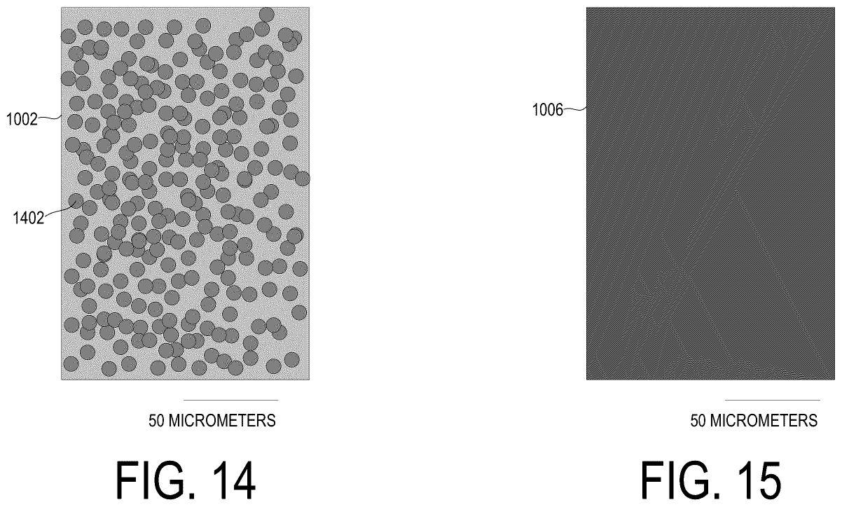

The mechanical adhesive 1002 may be any suitable adhesive, such as an epoxy or paste. The mechanical adhesive 1002 may be conducting or nonconducting. The mechanical adhesive 1002 may include filler material, such as particles 1402, as shown in FIG. 14, which depicts a cross-section of the mechanical adhesive 1002. In an illustrative embodiment, the particles 1402 are monodisperse silica particles with a diameter of about 800 nanometers. In other embodiments, the particles 1402 may be monodisperse or non-monodisperse. The particles 1402 may be of any suitable material, in addition to silica. The particles 1402 may have any suitable diameter, such as 200 nanometers to 10 micrometers. In the illustrative embodiment, the particles 1402 can affect the coefficient of thermal expansion (CTE), making it lower than the intrinsic CTE of the adhesive component of the mechanical adhesive 1002. The CTE of the mechanical adhesive 1002 may be, e.g., any value or range in the range of 0.2-10×10⁻⁶ K⁻¹. In an illustrative embodiment, the CTE of the mechanical adhesive 1002 may be similar to or between the CTEs of the PIC die 102 and the optical interposer 104. Matching the CTE of the mechanical adhesive 1002 to the CTE of the PIC die 102 and/or the optical interposer 104 may reduce the chance of delamination during further processing, packaging, and/or use of the PIC die 102. It should be appreciated that the particles 1402 may reduce the optical transmission of light through the mechanical adhesive 1002. However, as the mechanical adhesive 1002 is not present between the waveguides 106, 212, the particles 1402 in the mechanical adhesive 1002 do not result in a lower coupling of light between the waveguides 106, 212.

In an illustrative embodiment, the mechanical adhesive 1002 is applied as a relatively high-viscosity paste, allowing for limited flow or leaking of the mechanical adhesive 1002 when it is applied. In one embodiment, the mechanical adhesive 1002 is thermally curable. For example, a machine may be able to position the optical interposer 104 on the PIC die 102 and apply heat, curing the mechanical adhesive 1002. In some cases, such a machine may not be able to apply UV light while holding the optical interposer 104 in place relative to the PIC die 102, resulting in possible misalignment of the optical interposer 104 before a UV-cured mechanical adhesive 1002 could be cured. In other embodiments, the mechanical adhesive 1002 may be UV cured, and the optical interposer 104 may be held in place relative to the PIC die 102 while UV light is applied. The mechanical adhesive 1002 may have any suitable viscosity, such as a viscosity of 500-10,000,000 centipoise.

The index-matching material 1006 may be any suitable material, such as epoxy or paste. The index-matching material 1006 may have any suitable index of refraction, such as 1.4-3.6. In some embodiments, the index-matching material 1006 may have an index of refraction between that of the waveguide 106 and the waveguide 212, reducing reflective coupling loss at the interfaces of the waveguides 106, 212 and the index-matching material 1006. The index-matching material 1006 may not include particles, as shown in FIG. 15, resulting in a low optical loss for light transmitted through the index-matching material 1006. The index-matching material 1006 may have any suitable viscosity, such as a viscosity of 10-10,000 centipoise. In the illustrative embodiment, the index-matching material 1006 has a viscosity of 30-80 centipoise.

The CTE of the index-matching material 1006 may be relatively high, such as any value or range in the range of 10-100×10⁻⁶ K⁻¹. As there is a relatively small amount of index-matching material 1006 and as it is the mechanical adhesive 1002 that holds the optical interposer 104 in place relative to the PIC die 102, the relatively high CTE of the index-matching material 1006 does not result in excessive stress or separation of the optical interposer 104 from the PIC die 102.

In an illustrative embodiment, the index-matching material 1006 is applied as a relatively low-viscosity epoxy, allowing for the index-matching material 1006 to flow to fully fill the area between the waveguides 106, 212. As shown in FIGS. 10, 12, and 13, the index-matching material 1006 may flow into the trenches 206 and/or the trench 208. It should be appreciated that the index-matching material 1006 prevents the mechanical adhesive 1002 from being positioned between the waveguides 106, 212, which would reduce coupling between the waveguides 106, 212.

In an illustrative embodiment, the index-matching material 1006 is UV cured, and the mechanical adhesive 1002 is thermally cured. For example, in one embodiment, a machine may be able to position the optical interposer 104 on the PIC die 102 and apply heat, curing the mechanical adhesive 1002 without curing the index-matching material 1006. The mechanical adhesive 1002 can then hold the optical interposer 104 in place relative to the PIC die 102 while UV light is applied to cure the index-matching material 1006. In other embodiments, the index-matching material 1006 may be thermally cured and/or the mechanical adhesive 1002 may be UV cured.

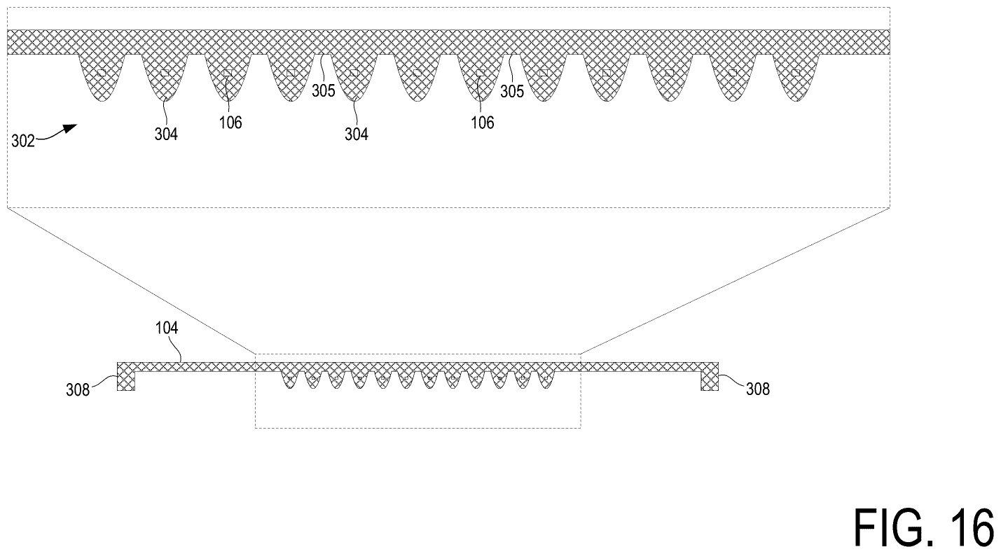

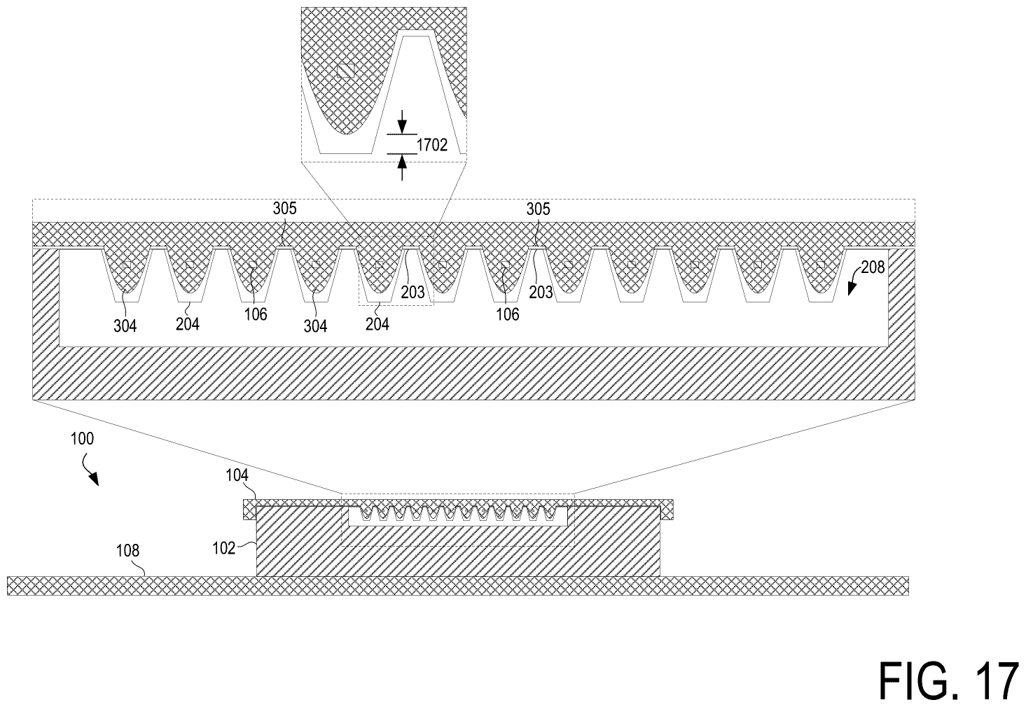

Referring now to FIGS. 16 and 17, in one embodiment, a cross-sectional view of the optical interposer 104 is shown in FIG. 16. The cross-sectional view of the optical interposer 104 in FIG. 16 is taken perpendicular to the V-grooves of the V-groove array 302. In an illustrative embodiment, the V-grooves of the V-groove array 302 are more rounded than the V-grooves of the V-groove arrays 202, 205, shown in FIGS. 6 and 7. FIG. 17 shows a cross-sectional view of the system 100, including the PIC die 102 and the optical interposer 104. The cross-sectional view of the system 100 in FIG. 16 is taken across the trench 208, perpendicular to the V-grooves of the V-groove arrays 202, 205. The mechanical adhesive 1002 and the index-matching material 1006 are omitted from FIG. 17 in the interest of clarity.

As shown in FIG. 17, the width of the valleys 305 of the V-grooves in the V-groove array 302 is wider than the peaks 203 of the V-grooves in the V-groove array 202, 205, allowing the peaks 203 to mechanically mate with the valleys 305. Such an approach avoids stresses that result from contact between the sidewalls of the V-grooves of the V-groove array 302 and the sidewalls of the V-grooves of the V-groove arrays 202, 205. Additionally or alternatively, the depth of the V-grooves of the V-groove array 302 is less than the depth of the V-grooves of the V-groove arrays 202, 205, resulting in a small gap 1702 between the peak 304 and the valley 204. Such a gap 1702 can reduce sensitivity to foreign matter, such as dust, that may be trapped between the V-groove array 302 and the V-groove arrays 202, 205. The gap 1702 may be any suitable amount, such as 2-50 micrometers.

Referring now to FIG. 18, in one embodiment, an integrated circuit package 1800 includes one or more PIC dies 102, one or more optical interposers 104, a substrate 1802, one or more optical sockets 1804, and an electrical integrated circuit (EIC) die 1806. In the illustrative embodiment, the optical sockets 1804 are formed from the substrate 1802 and an optical interposer 104. The optical interposer 104 has a face 1814 in which the ends of one or more waveguides are positioned. When an optical plug 1900 (see FIG. 19) is mated with the optical socket 1804, the optical fibers of the optical plug 1900 are lined up with the waveguides 306 in the optical interposer 104 to within, e.g., less than one micrometer.

In the illustrative embodiment, the optical socket 1804 is at least partially defined by a cavity 1818 defined in the substrate 1802. The illustrative cavity 1818 is cut all the way through the substrate 1802. The sidewalls of the cavity 1818 define coarse lateral alignment features for the optical plug 1900. The optical plug 1900 can be coarsely aligned vertically by a lid 1934 and another substrate 1932, as described below in more detail in regard to FIG. 19.

The cavity 1818 may include indents 1820 that act as latching features. The indents 1820 extend from the sidewalls of the cavity 1818 further inward into the substrate 1802. Protrusions 1930 of the optical plug 1900 can lock into position in the indents 1820, preventing the optical plug 1900 from being removed.

In the illustrative embodiments, the optical interposer 104 is positioned on a shelf 1816 that is slightly recessed from a top surface 1822 of the substrate 1802. The shelf 1816 may position the optical interposer 104 at a desired height relative to other components, such as the substrate 1802, the lid 1934, the plug 1900, etc. The shelf 1816 may have any suitable depth, such as 0-250 micrometers.

In the illustrative embodiment, a photonic integrated circuit (PIC) die 102 is mated with the optical interposer 104. In the illustrative embodiment, waveguides 306 in the optical interposer 104 can carry light between the optical fibers of the optical plug 1900 and waveguides the PIC dies 102.

The substrate 1802 may support several additional integrated circuit dies 1810, which may be PIC dies, EIC dies, or a combination of both. The additional integrated circuit dies 1810 may facilitate communication, power delivery, and other suitable connections between the PIC dies 102 and the EIC die 1806.

The illustrative substrate 1802 may be any suitable substrate, such as glass, silicon, ceramic, a circuit board, etc. In some embodiments, the substrate 1802 is a circuit board made from any suitable material, such as ceramic, glass, and/or organic-based materials with fiberglass and resin, such as FR-4. In some embodiments, the substrate 1802 is formed from or otherwise includes bismaleimide-triazine (BT) resin. The substrate 1802 may have any suitable length or width, such as 10-500 millimeters. The substrate 1802 may have any suitable thickness, such as 0.2-5 millimeters. The substrate 1802 may support additional components besides those shown in FIG. 1, such as resistors, capacitors, other integrated circuit dies, power electronics, traces, etc.

The EIC die 1806 may include any suitable electronic integrated circuit package, such as resistors, capacitors, inductors, transistors, etc. The EIC die 1806 may include any suitable analog and/or digital circuitry, such as a processor, a memory, an application-specific integrated circuit (ASIC), a field-programmable gate array (FPGA), etc. The EIC 1806 may be embodied as, form part of, or include a central processing unit (CPU), a graphics processing unit (GPU), or any other processing using (XPU). In some embodiments, the integrated circuit package 1800 may be embodied as a router, a switch, a network interface controller, and/or the like. In such embodiments, the EIC die 1806 may include network interface controller circuitry to process, parse, route, etc., network packets sent and received by the integrated circuit package 1800 through the optical plug 1900.

Referring now to FIG. 19, in one embodiment, an optical cable 1900 may be able to connect to the optical socket 1804 of the integrated circuit package 1800. The optical cable 1900 includes one or more optical fibers in a sheath 1906 connected to an optical plug 1902. Housing 1914 holds a ferrule and ferrule holder that mate with the optical interposer 104. As the plug 1902 is plugged into a socket, protrusions 1930 of a spring clip engage with the indents 1820 of the socket 1804, securing the optical plug 1902 in place. Pulling on tab 1920 of the retention mechanism will pull the protrusions 1930 of the spring clip inward, freeing the plug 1902 from the socket 1804.

The housing 1914 includes a slot 1924, which can be used to both coarsely align the plug 1902 as well as act as an orientation key, preventing the optical plug 1902 from being inserted upside down. The slot 1924 may interface with the rib 1940 shown in FIG. 19.

The optical cable 1900 may include any suitable number of optical fibers, such as 1-32 fibers. The optical fibers may be arranged at the ferrule in a one- or two-dimensional array. The illustrative optical fibers are made out of glass and can carry light at any suitable wavelength, such as 400-2,000 nanometers. In the illustrative embodiment, the optical fibers may support light in the C-band, O-band, L-band, S-band, etc. In other embodiments, the optical fibers may be made out of a different material.

The optical plug 1902 may have any suitable dimensions. In the illustrative embodiment, the optical plug 1902 has a width of about 5 millimeters and a height of about 1.5 millimeters. In other embodiments, the optical plug 1902 may have a height and/or width of, e.g., 1-10 millimeters. The optical cable 1900 may have an optical plug on the opposite end, which may be similar to, the same as, or different from the optical plug 1902.

In one embodiment, the integrated circuit component 1800 may be mounted on another component, such as a substrate 1932. The substrate 1932 may be, e.g., a motherboard, another circuit board connecting the integrated circuit package 1800 with other components, a housing, etc. The substrate 1932 may be a similar or the same material as the substrate 1802.

As shown in FIG. 19, in use, the integrated circuit package 1800 may include a lid 1934. The lid 1934 may provide coarse alignment for the plug 1902. The lid 1934 may have a rib 1940 that forms part of the socket 1804. The rib 1940 may align with a slot 1924 defined in the optical plug 1902. The rib 1940 and slot 1924 may establish a keying that prevents the optical plug 1902 from being inserted upside down.

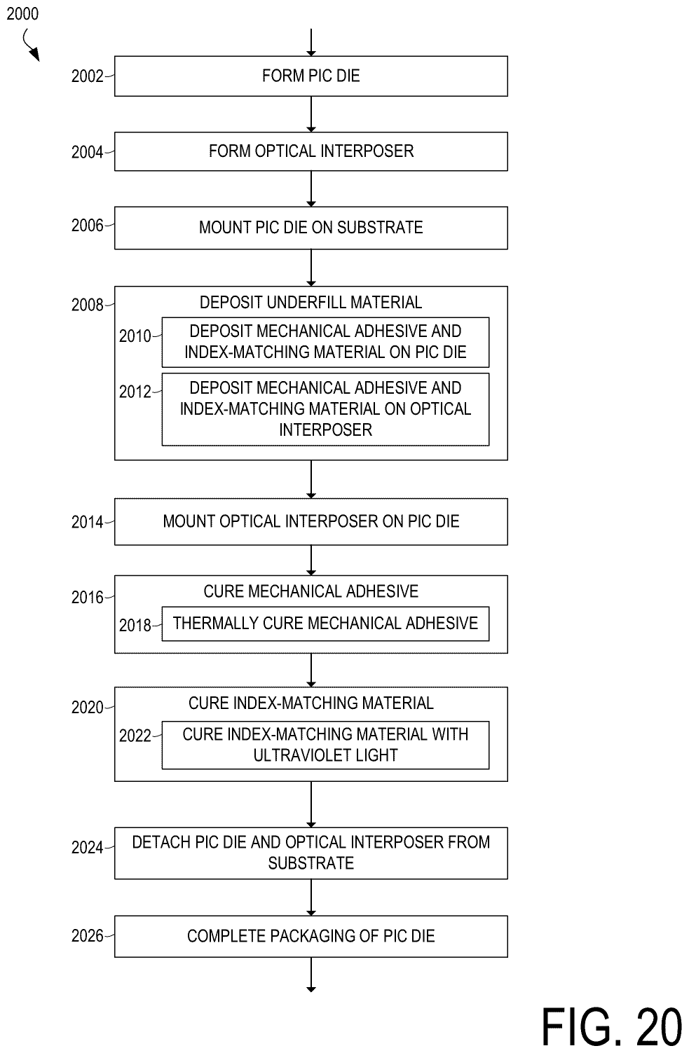

Referring now to FIG. 20, in one embodiment, a flowchart for a method 2000 for creating an integrated circuit package with an optical socket is shown. The method 2000 may be executed by a technician and/or by one or more automated machines. In some embodiments, one or more machines may be programmed to do some or all of the steps of the method 2000. Such a machine may include, e.g., a memory, a processor, data storage, etc. The memory and/or data storage may store instructions that, when executed by the machine, cause the machine to perform some or all of the steps of the method 2000. The method 2000 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, laser machining, 3D photolithography, etc. It should be appreciated that the method 2000 is merely one embodiment of a method to create one embodiment of a system and other methods may be used to create any suitable embodiment of the system. In some embodiments, steps of the method 2000 may be performed in a different order than that shown in the flowchart.

The method 2000 begins in block 2002, in which a PIC die 102 is formed. The PIC die 102 may include active or passive optical elements such as splitters, couplers, filters, optical amplifiers, lasers, photodetectors, modulators, etc. The PIC die 102 may include electrical connections for connections to a substrate and/or an EIC die, such as for power delivery, sending and receiving data, and/or the like.

In block 2004, an optical interposer 104 is formed. The optical interposer 104 may include one or more waveguides defined in the optical interposer 104. In the illustrative embodiment, the optical interposer 104 may be embodied as silica. In other embodiments, other glasses or other materials may be used, as described above in more detail. The optical interposer 104 may include one or more waveguides 306 defined in it. The waveguides 306 may be embodied as direct-write waveguides that are formed by applying a laser to the optical interposer 104 to modify the index of refraction of part of the optical interposer 104. The optical interposer 104 may be formed using, e.g., selective laser etching. In block 2006, the PIC die 102 is mounted on a substrate, such as the substrate 108.

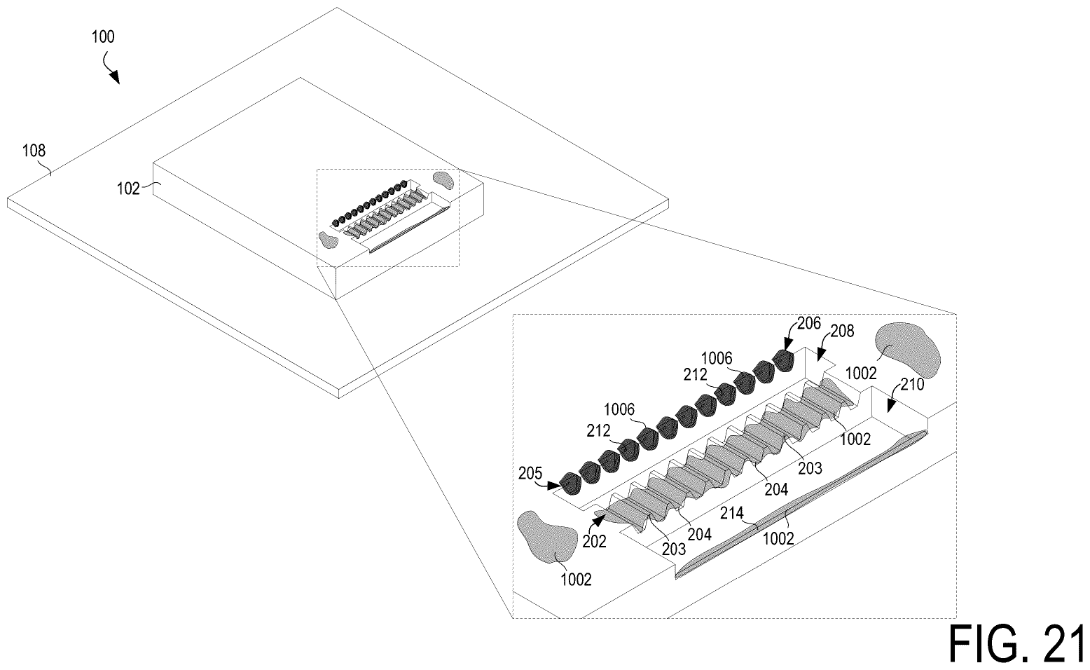

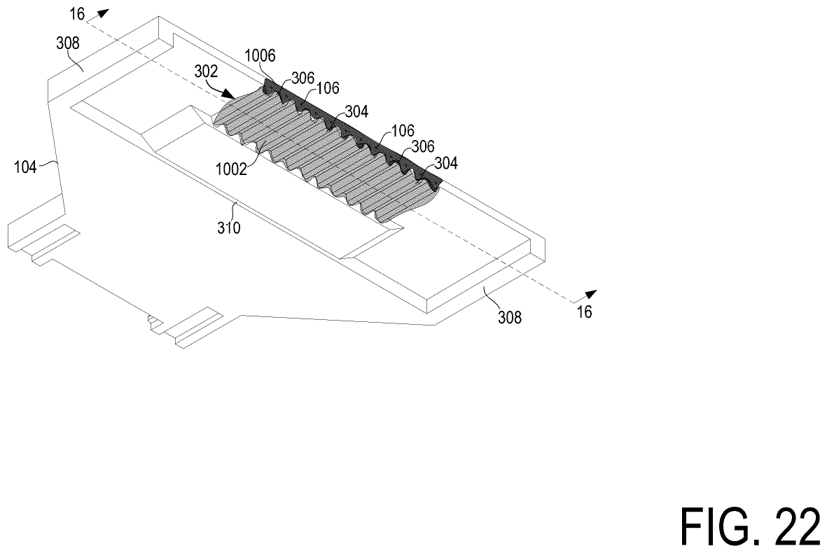

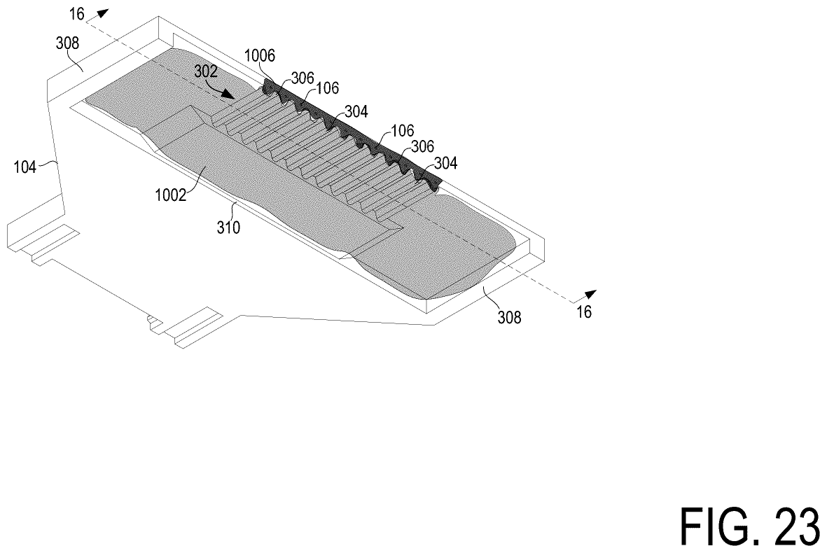

In block 2008, underfill material is deposited on the PIC die 102 and/or the optical interposer 104. In block 2010, mechanical adhesive 1002 and/or index matching material 1006 may be applied to the PIC die 102, as shown in FIG. 21. Additionally or alternatively, in block 2012, mechanical adhesive 1002 and/or index matching material 1006 may be applied to the optical interposer 104, as shown in FIGS. 22 and 23. In some embodiments, mechanical adhesive 1002 may be applied across the V-groove array 302, as shown in FIG. 22. Additionally or alternatively, mechanical adhesive 1002 may be applied to the wings of the optical interposer 104, as shown in FIG. 23.

In block 2014, the optical interposer 104 is mounted on the PIC die 102. The optical interposer 104 may be positioned such that the waveguides 306 are aligned to the waveguides 212 to within one micrometer or less. In block 2016, the mechanical adhesive 1002 is cured. In an illustrative embodiment, the mechanical adhesive 1002 is thermally cured in block 2018 while the optical interposer 104 is held in place relative to the PIC die 102.

In block 2020, the index-matching material 1006 is cured. In an illustrative embodiment, the index-matching material 1006 is cured with ultraviolet light in block 2022.

In block 2024, the PIC die 102 and optical interposer 104 are detached from the substrate 108. In block 2026, packaging of the PIC die 102 may be completed, such as by integrating the PIC die 102 and optical interposer 104 with a substrate, with an electronic integrated circuit die (EIC), etc.

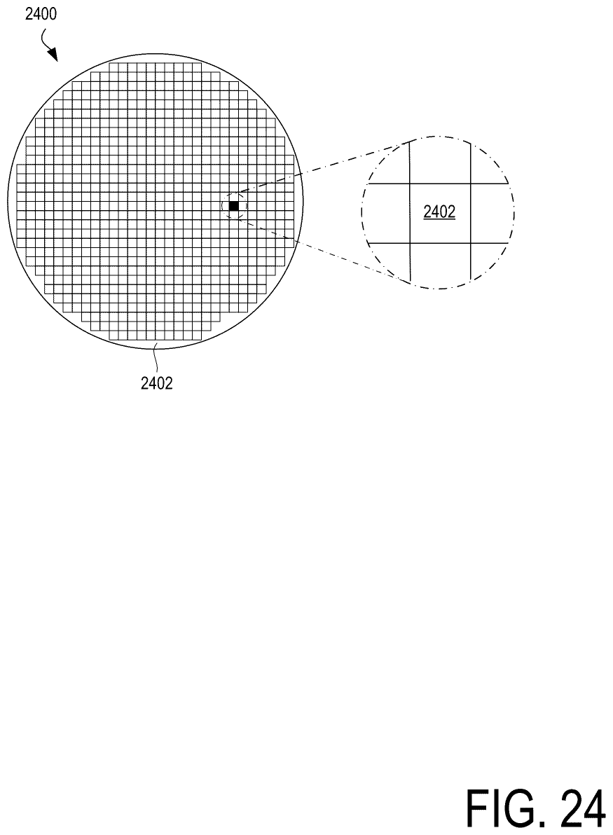

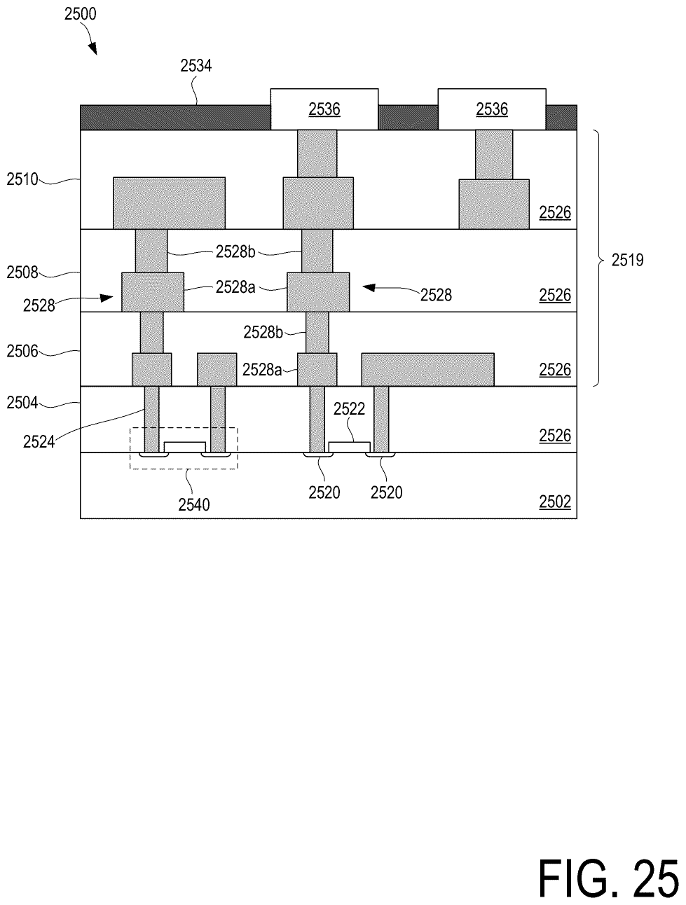

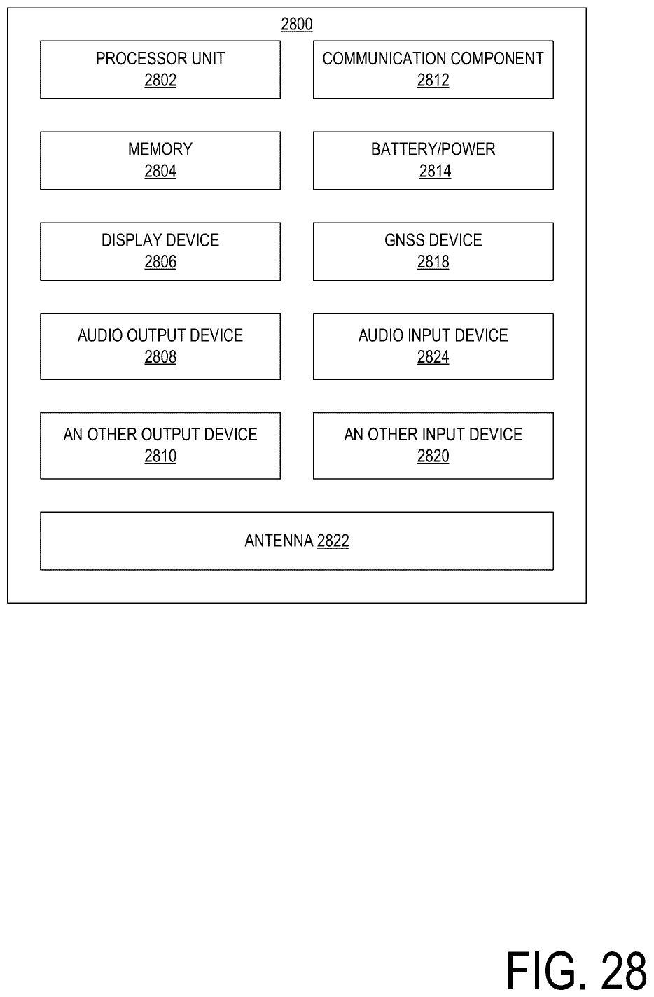

FIG. 24 is a top view of a wafer 2400 and dies 2402 that may be included in any of the integrated circuit packages 1800 disclosed herein (e.g., as any suitable ones of the dies 102, 1806). The wafer 2400 may be composed of semiconductor material and may include one or more dies 2402 having integrated circuit structures formed on a surface of the wafer 2400. The individual dies 2402 may be a repeating unit of an integrated circuit product that includes any suitable integrated circuit. After the fabrication of the semiconductor product is complete, the wafer 2400 may undergo a singulation process in which the dies 2402 are separated from one another to provide discrete “chips” of the integrated circuit product. The die 2402 may be any of the dies 102, 1806 disclosed herein. The die 2402 may include one or more transistors (e.g., some of the transistors 2540 of FIG. 25, discussed below), supporting circuitry to route electrical signals to the transistors, passive components (e.g., signal traces, resistors, capacitors, or inductors), and/or any other integrated circuit components. In some embodiments, the wafer 2400 or the die 2402 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 2402. For example, a memory array formed by multiple memory devices may be formed on a same die 2402 as a processor unit (e.g., the processor unit 2802 of FIG. 28) or other logic that is configured to store information in the memory devices or execute instructions stored in the memory array. Various ones of the integrated circuit packages 1800 disclosed herein may be manufactured using a die-to-wafer assembly technique in which some dies 102, 1806 are attached to a wafer 2400 that include others of the dies 102, 1806, and the wafer 2400 is subsequently singulated.

FIG. 25 is a cross-sectional side view of an integrated circuit device 2500 that may be included in any of the integrated circuit packages 1800 disclosed herein (e.g., in any of the dies 102, 1806). One or more of the integrated circuit devices 2500 may be included in one or more dies 2402 (FIG. 24). The integrated circuit device 2500 may be formed on a die substrate 2502 (e.g., the wafer 2400 of FIG. 24) and may be included in a die (e.g., the die 2402 of FIG. 24). The die substrate 2502 may be a semiconductor substrate composed of semiconductor material systems including, for example, n-type or p-type materials systems (or a combination of both). The die substrate 2502 may include, for example, a crystalline substrate formed using a bulk silicon or a silicon-on-insulator (SOI) substructure. In some embodiments, the die substrate 2502 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 2502. Although a few examples of materials from which the die substrate 2502 may be formed are described here, any material that may serve as a foundation for an integrated circuit device 2500 may be used. The die substrate 2502 may be part of a singulated die (e.g., the dies 2402 of FIG. 24) or a wafer (e.g., the wafer 2400 of FIG. 24).

The integrated circuit device 2500 may include one or more device layers 2504 disposed on the die substrate 2502. The device layer 2504 may include features of one or more transistors 2540 (e.g., metal oxide semiconductor field-effect transistors (MOSFETs)) formed on the die substrate 2502. The transistors 2540 may include, for example, one or more source and/or drain (S/D) regions 2520, a gate 2522 to control current flow between the S/D regions 2520, and one or more S/D contacts 2524 to route electrical signals to/from the S/D regions 2520. The transistors 2540 may include additional features not depicted for the sake of clarity, such as device isolation regions, gate contacts, and the like. The transistors 2540 are not limited to the type and configuration depicted in FIG. 25 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

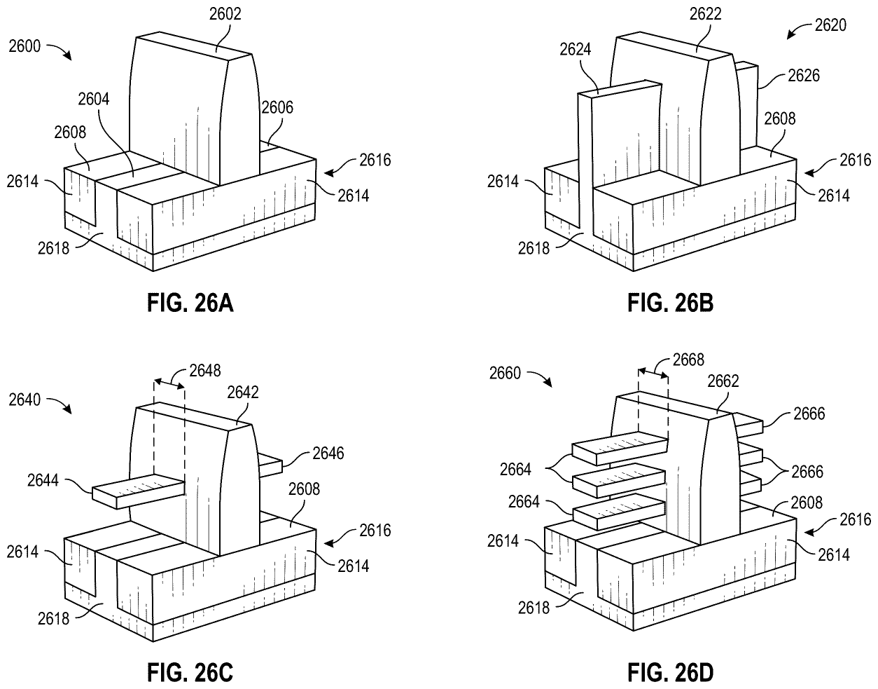

FIGS. 26A-26D are simplified perspective views of example planar, FinFET, gate-all-around, and stacked gate-all-around transistors. The transistors illustrated in FIGS. 26A-26D are formed on a substrate 2616 having a surface 2608. Isolation regions 2614 separate the source and drain regions of the transistors from other transistors and from a bulk region 2618 of the substrate 2616.

FIG. 26A is a perspective view of an example planar transistor 2600 comprising a gate 2602 that controls current flow between a source region 2604 and a drain region 2606. The transistor 2600 is planar in that the source region 2604 and the drain region 2606 are planar with respect to the substrate surface 2608.

FIG. 26B is a perspective view of an example FinFET transistor 2620 comprising a gate 2622 that controls current flow between a source region 2624 and a drain region 2626. The transistor 2620 is non-planar in that the source region 2624 and the drain region 2626 comprise “fins” that extend upwards from the substrate surface 2628. As the gate 2622 encompasses three sides of the semiconductor fin that extends from the source region 2624 to the drain region 2626, the transistor 2620 can be considered a tri-gate transistor. FIG. 26B illustrates one S/D fin extending through the gate 2622, but multiple S/D fins can extend through the gate of a FinFET transistor.

FIG. 26C is a perspective view of a gate-all-around (GAA) transistor 2640 comprising a gate 2642 that controls current flow between a source region 2644 and a drain region 2646. The transistor 2640 is non-planar in that the source region 2644 and the drain region 2646 are elevated from the substrate surface 2628.

FIG. 26D is a perspective view of a GAA transistor 2660 comprising a gate 2662 that controls current flow between multiple elevated source regions 2664 and multiple elevated drain regions 2666. The transistor 2660 is a stacked GAA transistor as the gate controls the flow of current between multiple elevated S/D regions stacked on top of each other. The transistors 2640 and 2660 are considered gate-all-around transistors as the gates encompass all sides of the semiconductor portions that extends from the source regions to the drain regions. The transistors 2640 and 2660 can alternatively be referred to as nanowire, nanosheet, or nanoribbon transistors depending on the width (e.g., widths 2648 and 2668 of transistors 2640 and 2660, respectively) of the semiconductor portions extending through the gate.

Returning to FIG. 25, a transistor 2540 may include a gate 2522 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 2540 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 2540 along the source-channel-drain direction, the gate electrode may consist of a U-shaped structure that includes a bottom portion substantially parallel to the surface of the die substrate 2502 and two sidewall portions that are substantially perpendicular to the top surface of the die substrate 2502. In other embodiments, at least one of the metal layers that form the gate electrode may simply be a planar layer that is substantially parallel to the top surface of the die substrate 2502 and does not include sidewall portions substantially perpendicular to the top surface of the die substrate 2502. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 2520 may be formed within the die substrate 2502 adjacent to the gate 2522 of individual transistors 2540. The S/D regions 2520 may be formed using an implantation/diffusion process or an etching/deposition process, for example. In the former process, dopants such as boron, aluminum, antimony, phosphorous, or arsenic may be ion-implanted into the die substrate 2502 to form the S/D regions 2520. An annealing process that activates the dopants and causes them to diffuse farther into the die substrate 2502 may follow the ion-implantation process. In the latter process, the die substrate 2502 may first be etched to form recesses at the locations of the S/D regions 2520. An epitaxial deposition process may then be carried out to fill the recesses with material that is used to fabricate the S/D regions 2520. In some implementations, the S/D regions 2520 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 2520 may be formed using one or more alternate semiconductor materials such as germanium or a group III-V material or alloy. In further embodiments, one or more layers of metal and/or metal alloys may be used to form the S/D regions 2520.

Electrical signals, such as power and/or input/output (I/O) signals, may be routed to and/or from the devices (e.g., transistors 2540) of the device layer 2504 through one or more interconnect layers disposed on the device layer 2504 (illustrated in FIG. 25 as interconnect layers 2506-2510). For example, electrically conductive features of the device layer 2504 (e.g., the gate 2522 and the S/D contacts 2524) may be electrically coupled with the interconnect structures 2528 of the interconnect layers 2506-2510. The one or more interconnect layers 2506-2510 may form a metallization stack (also referred to as an “ILD stack”) 2519 of the integrated circuit device 2500.

The interconnect structures 2528 may be arranged within the interconnect layers 2506-2510 to route electrical signals according to a wide variety of designs; in particular, the arrangement is not limited to the particular configuration of interconnect structures 2528 depicted in FIG. 25. Although a particular number of interconnect layers 2506-2510 is depicted in FIG. 25, embodiments of the present disclosure include integrated circuit devices having more or fewer interconnect layers than depicted.

In some embodiments, the interconnect structures 2528 may include lines 2528a and/or vias 2528b filled with an electrically conductive material such as a metal. The lines 2528a may be arranged to route electrical signals in a direction of a plane that is substantially parallel with a surface of the die substrate 2502 upon which the device layer 2504 is formed. For example, the lines 2528a may route electrical signals in a direction in and out of the page and/or in a direction across the page. The vias 2528b may be arranged to route electrical signals in a direction of a plane that is substantially perpendicular to the surface of the die substrate 2502 upon which the device layer 2504 is formed. In some embodiments, the vias 2528b may electrically couple lines 2528a of different interconnect layers 2506-2510 together.

The interconnect layers 2506-2510 may include a dielectric material 2526 disposed between the interconnect structures 2528, as shown in FIG. 25. In some embodiments, dielectric material 2526 disposed between the interconnect structures 2528 in different ones of the interconnect layers 2506-2510 may have different compositions; in other embodiments, the composition of the dielectric material 2526 between different interconnect layers 2506-2510 may be the same. The device layer 2504 may include a dielectric material 2526 disposed between the transistors 2540 and a bottom layer of the metallization stack as well. The dielectric material 2526 included in the device layer 2504 may have a different composition than the dielectric material 2526 included in the interconnect layers 2506-2510; in other embodiments, the composition of the dielectric material 2526 in the device layer 2504 may be the same as a dielectric material 2526 included in any one of the interconnect layers 2506-2510.

A first interconnect layer 2506 (referred to as Metal 1 or “M1”) may be formed directly on the device layer 2504. In some embodiments, the first interconnect layer 2506 may include lines 2528a and/or vias 2528b, as shown. The lines 2528a of the first interconnect layer 2506 may be coupled with contacts (e.g., the S/D contacts 2524) of the device layer 2504. The vias 2528b of the first interconnect layer 2506 may be coupled with the lines 2528a of a second interconnect layer 2508.

The second interconnect layer 2508 (referred to as Metal 2 or “M2”) may be formed directly on the first interconnect layer 2506. In some embodiments, the second interconnect layer 2508 may include via 2528b to couple the lines 2528 of the second interconnect layer 2508 with the lines 2528a of a third interconnect layer 2510. Although the lines 2528a and the vias 2528b are structurally delineated with a line within individual interconnect layers for the sake of clarity, the lines 2528a and the vias 2528b may be structurally and/or materially contiguous (e.g., simultaneously filled during a dual-damascene process) in some embodiments.

The third interconnect layer 2510 (referred to as Metal 3 or “M3”) (and additional interconnect layers, as desired) may be formed in succession on the second interconnect layer 2508 according to similar techniques and configurations described in connection with the second interconnect layer 2508 or the first interconnect layer 2506. In some embodiments, the interconnect layers that are “higher up” in the metallization stack 2519 in the integrated circuit device 2500 (i.e., farther away from the device layer 2504) may be thicker that the interconnect layers that are lower in the metallization stack 2519, with lines 2528a and vias 2528b in the higher interconnect layers being thicker than those in the lower interconnect layers.

The integrated circuit device 2500 may include a solder resist material 2534 (e.g., polyimide or similar material) and one or more conductive contacts 2536 formed on the interconnect layers 2506-2510. In FIG. 25, the conductive contacts 2536 are illustrated as taking the form of bond pads. The conductive contacts 2536 may be electrically coupled with the interconnect structures 2528 and configured to route the electrical signals of the transistor(s) 2540 to external devices. For example, solder bonds may be formed on the one or more conductive contacts 2536 to mechanically and/or electrically couple an integrated circuit die including the integrated circuit device 2500 with another component (e.g., a printed circuit board). The integrated circuit device 2500 may include additional or alternate structures to route the electrical signals from the interconnect layers 2506-2510; for example, the conductive contacts 2536 may include other analogous features (e.g., posts) that route the electrical signals to external components.

In some embodiments in which the integrated circuit device 2500 is a double-sided die, the integrated circuit device 2500 may include another metallization stack (not shown) on the opposite side of the device layer(s) 2504. This metallization stack may include multiple interconnect layers as discussed above with reference to the interconnect layers 2506-2510, to provide conductive pathways (e.g., including conductive lines and vias) between the device layer(s) 2504 and additional conductive contacts (not shown) on the opposite side of the integrated circuit device 2500 from the conductive contacts 2536.

In other embodiments in which the integrated circuit device 2500 is a double-sided die, the integrated circuit device 2500 may include one or more through silicon vias (TSVs) through the die substrate 2502; these TSVs may make contact with the device layer(s) 2504, and may provide conductive pathways between the device layer(s) 2504 and additional conductive contacts (not shown) on the opposite side of the integrated circuit device 2500 from the conductive contacts 2536. In some embodiments, TSVs extending through the substrate can be used for routing power and ground signals from conductive contacts on the opposite side of the integrated circuit device 2500 from the conductive contacts 2536 to the transistors 2540 and any other components integrated into the die 2500, and the metallization stack 2519 can be used to route I/O signals from the conductive contacts 2536 to transistors 2540 and any other components integrated into the die 2500.

Multiple integrated circuit devices 2500 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

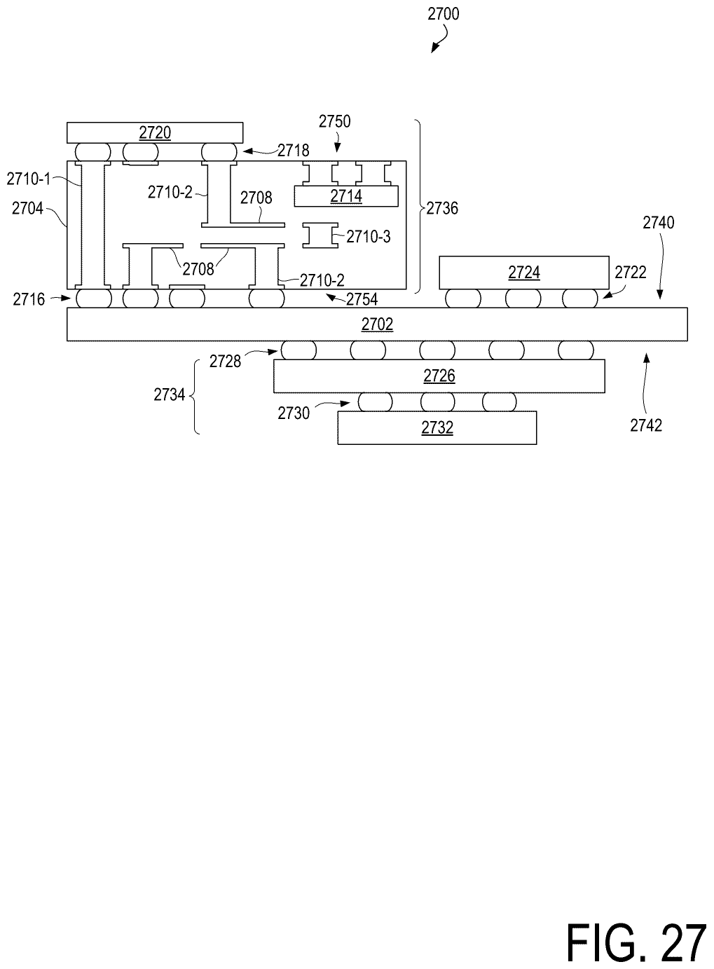

FIG. 27 is a cross-sectional side view of an integrated circuit device assembly 2700 that may include any of the integrated circuit packages 1800 disclosed herein. In some embodiments, the integrated circuit device assembly 2700 may be an integrated circuit packages 1800. The integrated circuit device assembly 2700 includes a number of components disposed on a circuit board 2702 (which may be a motherboard, system board, mainboard, etc.). The integrated circuit device assembly 2700 includes components disposed on a first face 2740 of the circuit board 2702 and an opposing second face 2742 of the circuit board 2702; generally, components may be disposed on one or both faces 2740 and 2742. Any of the integrated circuit components discussed below with reference to the integrated circuit device assembly 2700 may take the form of any suitable ones of the embodiments of the integrated circuit packages 1800 disclosed herein.

In some embodiments, the circuit board 2702 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 2702. In other embodiments, the circuit board 2702 may be a non-PCB substrate. In some embodiments the circuit board 2702 may be, for example, the circuit board 1802 or 1932. The integrated circuit device assembly 2700 illustrated in FIG. 27 includes a package-on-interposer structure 2736 coupled to the first face 2740 of the circuit board 2702 by coupling components 2716. The coupling components 2716 may electrically and mechanically couple the package-on-interposer structure 2736 to the circuit board 2702, and may include solder balls (as shown in FIG. 27), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 2716 may serve as the coupling components illustrated or described for any of the substrate assembly or substrate assembly components described herein, as appropriate.

The package-on-interposer structure 2736 may include an integrated circuit component 2720 coupled to an interposer 2704 by coupling components 2718. The coupling components 2718 may take any suitable form for the application, such as the forms discussed above with reference to the coupling components 2716. Although a single integrated circuit component 2720 is shown in FIG. 27, multiple integrated circuit components may be coupled to the interposer 2704; indeed, additional interposers may be coupled to the interposer 2704. The interposer 2704 may provide an intervening substrate used to bridge the circuit board 2702 and the integrated circuit component 2720.

The integrated circuit component 2720 may be a packaged or unpacked integrated circuit product that includes one or more integrated circuit dies (e.g., the die 2402 of FIG. 24, the integrated circuit device 2500 of FIG. 25) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 2720, a single monolithic integrated circuit die comprises solder bumps attached to contacts on the die. The solder bumps allow the die to be directly attached to the interposer 2704. The integrated circuit component 2720 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 2720 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 2720 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 2720 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 2704 may spread connections to a wider pitch or reroute a connection to a different connection. For example, the interposer 2704 may couple the integrated circuit component 2720 to a set of ball grid array (BGA) conductive contacts of the coupling components 2716 for coupling to the circuit board 2702. In the embodiment illustrated in FIG. 27, the integrated circuit component 2720 and the circuit board 2702 are attached to opposing sides of the interposer 2704; in other embodiments, the integrated circuit component 2720 and the circuit board 2702 may be attached to a same side of the interposer 2704. In some embodiments, three or more components may be interconnected by way of the interposer 2704.

In some embodiments, the interposer 2704 may be formed as a PCB, including multiple metal layers separated from one another by layers of dielectric material and interconnected by electrically conductive vias. In some embodiments, the interposer 2704 may be formed of an epoxy resin, a fiberglass-reinforced epoxy resin, an epoxy resin with inorganic fillers, a ceramic material, or a polymer material such as polyimide. In some embodiments, the interposer 2704 may be formed of alternate rigid or flexible materials that may include the same materials described above for use in a semiconductor substrate, such as silicon, germanium, and other group III-V and group IV materials. The interposer 2704 may include metal interconnects 2708 and vias 2710, including but not limited to through hole vias 2710-1 (that extend from a first face 2750 of the interposer 2704 to a second face 2754 of the interposer 2704), blind vias 2710-2 (that extend from the first or second faces 2750 or 2754 of the interposer 2704 to an internal metal layer), and buried vias 2710-3 (that connect internal metal layers).

In some embodiments, the interposer 2704 can comprise a silicon interposer. Through silicon vias (TSV) extending through the silicon interposer can connect connections on a first face of a silicon interposer to an opposing second face of the silicon interposer. In some embodiments, an interposer 2704 comprising a silicon interposer can further comprise one or more routing layers to route connections on a first face of the interposer 2704 to an opposing second face of the interposer 2704.

The interposer 2704 may further include embedded devices 2714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2704. The package-on-interposer structure 2736 may take the form of any of the package-on-interposer structures known in the art.

The integrated circuit device assembly 2700 may include an integrated circuit component 2724 coupled to the first face 2740 of the circuit board 2702 by coupling components 2722. The coupling components 2722 may take the form of any of the embodiments discussed above with reference to the coupling components 2716, and the integrated circuit component 2724 may take the form of any of the embodiments discussed above with reference to the integrated circuit component 2720.

The integrated circuit device assembly 2700 illustrated in FIG. 27 includes a package-on-package structure 2734 coupled to the second face 2742 of the circuit board 2702 by coupling components 2728. The package-on-package structure 2734 may include an integrated circuit component 2726 and an integrated circuit component 2732 coupled together by coupling components 2730 such that the integrated circuit component 2726 is disposed between the circuit board 2702 and the integrated circuit component 2732. The coupling components 2728 and 2730 may take the form of any of the embodiments of the coupling components 2716 discussed above, and the integrated circuit components 2726 and 2732 may take the form of any of the embodiments of the integrated circuit component 2720 discussed above. The package-on-package structure 2734 may be configured in accordance with any of the package-on-package structures known in the art.

FIG. 28 is a block diagram of an example electrical device 2800 that may include one or more of the integrated circuit packages 1800 disclosed herein. For example, any suitable ones of the components of the electrical device 2800 may include one or more of the integrated circuit device assemblies 2700, integrated circuit components 2720, integrated circuit devices 2500, or integrated circuit dies 2402 disclosed herein, and may be arranged in any of the integrated circuit packages 1800 disclosed herein. A number of components are illustrated in FIG. 28 as included in the electrical device 2800, but any one or more of these components may be omitted or duplicated, as suitable for the application. In some embodiments, some or all of the components included in the electrical device 2800 may be attached to one or more motherboards mainboards, or system boards. In some embodiments, one or more of these components are fabricated onto a single system-on-a-chip (SoC) die.

Additionally, in various embodiments, the electrical device 2800 may not include one or more of the components illustrated in FIG. 28, but the electrical device 2800 may include interface circuitry for coupling to the one or more components. For example, the electrical device 2800 may not include a display device 2806, but may include display device interface circuitry (e.g., a connector and driver circuitry) to which a display device 2806 may be coupled. In another set of examples, the electrical device 2800 may not include an audio input device 2824 or an audio output device 2808, but may include audio input or output device interface circuitry (e.g., connectors and supporting circuitry) to which an audio input device 2824 or audio output device 2808 may be coupled.

The electrical device 2800 may include one or more processor units 2802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 2802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 2800 may include a memory 2804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 2804 may include memory that is located on the same integrated circuit die as the processor unit 2802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 2800 can comprise one or more processor units 2802 that are heterogeneous or asymmetric to another processor unit 2802 in the electrical device 2800. There can be a variety of differences between the processing units 2802 in a system in terms of a spectrum of metrics of merit including architectural, microarchitectural, thermal, power consumption characteristics, and the like. These differences can effectively manifest themselves as asymmetry and heterogeneity among the processor units 2802 in the electrical device 2800.

In some embodiments, the electrical device 2800 may include a communication component 2812 (e.g., one or more communication components). For example, the communication component 2812 can manage wireless communications for the transfer of data to and from the electrical device 2800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 2812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 2812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 2812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 2812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 2812 may operate in accordance with other wireless protocols in other embodiments. The electrical device 2800 may include an antenna 2822 to facilitate wireless communications and/or to receive other wireless communications (such as AM or FM radio transmissions).

In some embodiments, the communication component 2812 may manage wired communications, such as electrical, optical, or any other suitable communication protocols (e.g., IEEE 802.3 Ethernet standards). As noted above, the communication component 2812 may include multiple communication components. For instance, a first communication component 2812 may be dedicated to shorter-range wireless communications such as Wi-Fi or Bluetooth, and a second communication component 2812 may be dedicated to longer-range wireless communications such as global positioning system (GPS), EDGE, GPRS, CDMA, WiMAX, LTE, EV-DO, or others. In some embodiments, a first communication component 2812 may be dedicated to wireless communications, and a second communication component 2812 may be dedicated to wired communications.

The electrical device 2800 may include battery/power circuitry 2814. The battery/power circuitry 2814 may include one or more energy storage devices (e.g., batteries or capacitors) and/or circuitry for coupling components of the electrical device 2800 to an energy source separate from the electrical device 2800 (e.g., AC line power).

The electrical device 2800 may include a display device 2806 (or corresponding interface circuitry, as discussed above). The display device 2806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 2800 may include an audio output device 2808 (or corresponding interface circuitry, as discussed above). The audio output device 2808 may include any embedded or wired or wirelessly connected external device that generates an audible indicator, such as speakers, headsets, or earbuds.

The electrical device 2800 may include an audio input device 2824 (or corresponding interface circuitry, as discussed above). The audio input device 2824 may include any embedded or wired or wirelessly connected device that generates a signal representative of a sound, such as microphones, microphone arrays, or digital instruments (e.g., instruments having a musical instrument digital interface (MIDI) output). The electrical device 2800 may include a Global Navigation Satellite System (GNSS) device 2818 (or corresponding interface circuitry, as discussed above), such as a Global Positioning System (GPS) device. The GNSS device 2818 may be in communication with a satellite-based system and may determine a geolocation of the electrical device 2800 based on information received from one or more GNSS satellites, as known in the art.

The electrical device 2800 may include an other output device 2810 (or corresponding interface circuitry, as discussed above). Examples of the other output device 2810 may include an audio codec, a video codec, a printer, a wired or wireless transmitter for providing information to other devices, or an additional storage device.

The electrical device 2800 may include an other input device 2820 (or corresponding interface circuitry, as discussed above). Examples of the other input device 2820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 2800 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 2800 may be any other electronic device that processes data. In some embodiments, the electrical device 2800 may comprise multiple discrete physical components. Given the range of devices that the electrical device 2800 can be manifested as in various embodiments, in some embodiments, the electrical device 2800 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising a photonic integrated circuit (PIC) die comprising one or more waveguides; an optical interposer mated with the PIC die, the optical interposer comprising one or more waveguides, wherein individual waveguides of the one or more waveguides of the optical interposer are aligned to individual waveguides of the one or more waveguides of the PIC die; mechanical adhesive securing the optical interposer to the PIC die; and index-matching material between the one or more waveguides of the PIC die and the one or more waveguides of the optical interposer, wherein the mechanical adhesive is different from the index-matching material.

Example 2 includes the subject matter of Example 1, and wherein the mechanical adhesive comprises monodisperse particles suspended in the mechanical adhesive.

Example 3 includes the subject matter of any of Examples 1 and 2, and wherein a diameter of the monodisperse particles is between 500 nanometers and 5 micrometers.

Example 4 includes the subject matter of any of Examples 1-3, and wherein a coefficient of thermal expansion (CTE) of the mechanical adhesive is less than 10−5 K−1, wherein a CTE of the index-matching material is more than 2×10−5 K−1.

Example 5 includes the subject matter of any of Examples 1-4, and wherein the mechanical adhesive is thermally cured, wherein the index-matching material is ultraviolet-light cured.

Example 6 includes the subject matter of any of Examples 1-5, and wherein the optical interposer comprises one or more V-grooves defined in a surface of the optical interposer, wherein the PIC die comprises one or more V-grooves defined in a surface of the PIC die, wherein the one or more V-grooves of the PIC die are mated with the one or more V-grooves of the optical interposer, wherein at least part of the mechanical adhesive is positioned between the one or more V-grooves of the PIC die and the one or more V-grooves of the optical interposer.

Example 7 includes the subject matter of any of Examples 1-6, and wherein the optical interposer further comprises wings that extend from an area of the optical interposer with the one or more V-grooves to sides of the optical interposer, wherein at least part of the mechanical adhesive is positioned between the wings and a surface of the PIC die.

Example 8 includes the subject matter of any of Examples 1-7, and wherein the optical interposer extends past an edge of the PIC die, wherein a side wall of the optical interposer extends below a plane defined by the surface of the PIC die, wherein at least part of the mechanical adhesive is positioned between the side wall of the optical interposer and a side wall of the PIC die.

Example 9 includes the subject matter of any of Examples 1-8, and wherein the one or more V-grooves of the PIC die comprise one or more peaks and one or more valleys, wherein the one or more V-grooves of the optical interposer comprise one or more peaks and one or more valleys, wherein individual peaks of the one or more peaks of the one or more V-grooves of the PIC die mate with individual valleys of the one or more valleys of the one or more V-grooves of the optical interposer.

Example 10 includes the subject matter of any of Examples 1-9, and wherein sidewalls of individual V-grooves of the one or more V-groves of the optical interposer do not apply stress to sidewalls of individual V-grooves of the one or more V-groves of the PIC die.

Example 11 includes the subject matter of any of Examples 1-10, and wherein one or more trenches are defined in the PIC die between the one or more waveguides of the PIC die and the one or more V-grooves of the PIC die, wherein the index-matching material at least partially fills the one or more trenches.

Example 12 includes the subject matter of any of Examples 1-11, and wherein the PIC die comprises one or more additional V-grooves defined in the surface of the PIC die, wherein the one or more additional V-grooves of the PIC die are mated with the one or more V-grooves of the optical interposer, wherein a trench is defined in the PIC die between the one or more V-grooves of the PIC die and the one or more additional V-grooves of the PIC die.

Example 13 includes the subject matter of any of Examples 1-12, and wherein more than half of the trench is filled with the mechanical adhesive.

Example 14 includes the subject matter of any of Examples 1-13, and wherein more than half of the trench is filled with the index-matching material.

Example 15 includes the subject matter of any of Examples 1-14, and wherein a trench is defined in the PIC die between the one or more V-grooves of the PIC die and a wall at a side surface of the PIC die, wherein the mechanical adhesive fills at least part of the trench.

Example 16 includes an integrated circuit package comprising the apparatus of Example 1, further comprising one or more electronic integrated circuit (EIC) dies, wherein the one or more EIC dies are electrically coupled to the PIC die.

Example 17 includes the subject matter of Example 16, and further including an optical plug mated with the optical interposer.

Example 18 includes the subject matter of any of Examples 16 and 17, and wherein the one or more waveguides of the optical interposer comprise at least eight waveguides.

Example 19 includes an apparatus comprising a photonic integrated circuit (PIC) die comprising one or more waveguides; one or more V-grooves defined in a surface of the PIC die, the one or more V-grooves of the PIC die comprising one or more peaks and one or more valleys; and an optical interposer mated with the PIC die, the optical interposer comprising one or more waveguides, wherein individual waveguides of the one or more waveguides of the optical interposer are aligned to individual waveguides of the one or more waveguides of the PIC die; and one or more V-grooves defined in a surface of the optical interposer, the one or more V-grooves of the optical interposer comprising one or more peaks and one or more valleys, wherein individual peaks of the one or more peaks of the one or more V-grooves of the PIC die mate with individual valleys of the one or more valleys of the one or more V-grooves of the optical interposer.

Example 20 includes the subject matter of Example 19, and wherein sidewalls of individual V-grooves of the one or more V-groves of the optical interposer do not apply stress to sidewalls of individual V-grooves of the one or more V-groves of the PIC die.

Example 21 includes the subject matter of any of Examples 19 and 20, and wherein one or more trenches are defined in the PIC die between the one or more waveguides of the PIC die and the one or more V-grooves of the PIC die, wherein index-matching material at least partially fills the one or more trenches.

Example 22 includes the subject matter of any of Examples 19-21, and wherein the PIC die comprises one or more additional V-grooves defined in the surface of the PIC die, wherein the one or more additional V-grooves of the PIC die are mated with the one or more V-grooves of the optical interposer, wherein a trench is defined in the PIC die between the one or more V-grooves of the PIC die and the one or more additional V-grooves of the PIC die.

Example 23 includes the subject matter of any of Examples 19-22, and wherein more than half of the trench is filled with mechanical adhesive.

Example 24 includes the subject matter of any of Examples 19-23, and wherein more than half of the trench is filled with index-matching material.

Example 25 includes the subject matter of any of Examples 19-24, and wherein a trench is defined in the PIC die between the one or more V-grooves of the PIC die and a wall at a side surface of the PIC die, wherein mechanical adhesive fills at least part of the trench.

Example 26 includes the subject matter of any of Examples 19-25, and further including mechanical adhesive securing the optical interposer to the PIC die; and index-matching material between the one or more waveguides of the PIC die and the one or more waveguides of the optical interposer, wherein the mechanical adhesive is different from the index-matching material.

Example 27 includes the subject matter of any of Examples 19-26, and wherein the mechanical adhesive comprises monodisperse particles suspended in the mechanical adhesive.

Example 28 includes the subject matter of any of Examples 19-27, and wherein a diameter of the monodisperse particles is between 500 nanometers and 5 micrometers.

Example 29 includes the subject matter of any of Examples 19-28, and wherein a coefficient of thermal expansion (CTE) of the mechanical adhesive is less than 10−5 K−1, wherein a CTE of the index-matching material is more than 2×10−5 K−1.

Example 30 includes the subject matter of any of Examples 19-29, and wherein the mechanical adhesive is thermally cured, wherein the index-matching material is ultraviolet-light cured.

Example 31 includes the subject matter of any of Examples 19-30, and wherein at least part of the mechanical adhesive is positioned between the one or more V-grooves of the PIC die and the one or more V-grooves of the optical interposer.

Example 32 includes the subject matter of any of Examples 19-31, and wherein the optical interposer further comprises wings that extend from an area of the optical interposer with the one or more V-grooves to sides of the optical interposer, wherein at least part of the mechanical adhesive is positioned between the wings and a surface of the PIC die.

Example 33 includes the subject matter of any of Examples 19-32, and wherein the optical interposer extends past an edge of the PIC die, wherein a side wall of the optical interposer extends below a plane defined by the surface of the PIC die, wherein at least part of the mechanical adhesive is positioned between the side wall of the optical interposer and a side wall of the PIC die.

Example 34 includes an integrated circuit package comprising the apparatus of Example 19, further comprising one or more electronic integrated circuit (EIC) dies, wherein the one or more EIC dies are electrically coupled to the PIC die.

Example 35 includes the subject matter of Example 34, and further including an optical plug mated with the optical interposer.

Example 36 includes the subject matter of any of Examples 34 and 35, and wherein the one or more waveguides of the optical interposer comprise at least eight waveguides.

Example 37 includes a method comprising positioning an optical interposer on a photonic integrated circuit (PIC) die, wherein the optical interposer comprises one or more waveguides, wherein the PIC die comprises one or more waveguides, wherein the optical interposer is positioned such that individual waveguides of the one or more waveguides of the optical interposer are aligned to individual waveguides of the one or more waveguides of the PIC die, wherein index-matching material is positioned between the one or more waveguides of the PIC die and the one or more waveguides of the optical interposer, wherein mechanical adhesive is positioned between at least part of the optical interposer and at least part of the PIC die; thermally curing the mechanical adhesive without curing the index-matching material; and curing the index-matching material using ultraviolet light after thermally curing the mechanical adhesive.

Example 38 includes the subject matter of Example 37, and wherein the PIC die comprises a wall at a side surface of the PIC die, wherein the wall forms part of a trench defined in the PIC die, wherein the wall prevents at least one of the mechanical adhesive and the index-matching material from leaking down the side surface of the PIC die before being cured.

Example 39 includes the subject matter of any of Examples 37 and 38, and wherein the mechanical adhesive has a viscosity more than 10,000 centipoise before curing, wherein the index-matching material has a viscosity less than 1,000 centipoise before curing.

Example 40 includes the subject matter of any of Examples 37-39, and wherein the mechanical adhesive comprises monodisperse particles suspended in the mechanical adhesive.

Example 41 includes the subject matter of any of Examples 37-40, and wherein a diameter of the monodisperse particles is between 500 nanometers and 5 micrometers.

Example 42 includes the subject matter of any of Examples 37-41, and wherein a coefficient of thermal expansion (CTE) of the mechanical adhesive is less than 10−5 K−1, wherein a CTE of the index-matching material is more than 2×10−5 K−1.

Example 43 includes the subject matter of any of Examples 37-42, and wherein the mechanical adhesive is thermally cured, wherein the index-matching material is ultraviolet-light cured.

Example 44 includes the subject matter of any of Examples 37-43, and wherein the optical interposer comprises one or more V-grooves defined in a surface of the optical interposer, wherein the PIC die comprises one or more V-grooves defined in a surface of the PIC die, wherein the one or more V-grooves of the PIC die are mated with the one or more V-grooves of the optical interposer, wherein at least part of the mechanical adhesive is positioned between the one or more V-grooves of the PIC die and the one or more V-grooves of the optical interposer.

Example 45 includes the subject matter of any of Examples 37-44, and wherein the optical interposer further comprises wings that extend from an area of the optical interposer with the one or more V-grooves to sides of the optical interposer, wherein at least part of the mechanical adhesive is positioned between the wings and a surface of the PIC die.

Example 46 includes the subject matter of any of Examples 37-45, and wherein the optical interposer extends past an edge of the PIC die, wherein a side wall of the optical interposer extends below a plane defined by the surface of the PIC die, wherein at least part of the mechanical adhesive is positioned between the side wall of the optical interposer and a side wall of the PIC die.

Example 47 includes the subject matter of any of Examples 37-46, and wherein the one or more V-grooves of the PIC die comprise one or more peaks and one or more valleys, wherein the one or more V-grooves of the optical interposer comprise one or more peaks and one or more valleys, wherein individual peaks of the one or more peaks of the one or more V-grooves of the PIC die mate with individual valleys of the one or more valleys of the one or more V-grooves of the optical interposer.

Example 48 includes the subject matter of any of Examples 37-47, and wherein sidewalls of individual V-grooves of the one or more V-groves of the optical interposer do not apply stress to sidewalls of individual V-grooves of the one or more V-groves of the PIC die.

Example 49 includes the subject matter of any of Examples 37-48, and wherein one or more trenches are defined in the PIC die between the one or more waveguides of the PIC die and the one or more V-grooves of the PIC die, wherein the index-matching material at least partially fills the one or more trenches.

Example 50 includes the subject matter of any of Examples 37-49, and wherein the PIC die comprises one or more additional V-grooves defined in the surface of the PIC die, wherein the one or more additional V-grooves of the PIC die are mated with the one or more V-grooves of the optical interposer, wherein a trench is defined in the PIC die between the one or more V-grooves of the PIC die and the one or more additional V-grooves of the PIC die.

Example 51 includes the subject matter of any of Examples 37-50, and wherein more than half of the trench is filled with the mechanical adhesive.

Example 52 includes the subject matter of any of Examples 37-51, and wherein more than half of the trench is filled with the index-matching material.

Example 53 includes the subject matter of any of Examples 37-52, and wherein a trench is defined in the PIC die between the one or more V-grooves of the PIC die and a wall at a side surface of the PIC die, wherein the mechanical adhesive fills at least part of the trench.

Example 54 includes the subject matter of any of Examples 37-53, and further including mating an optical plug with the optical interposer.

Example 55 includes the subject matter of any of Examples 37-54, and wherein the one or more waveguides of the optical interposer comprise at least eight waveguides.

The invention claimed is:

1. An apparatus comprising:
a photonic integrated circuit (PIC) die comprising one or more waveguides;
an optical interposer mated with the PIC die, the optical interposer comprising one or more waveguides, wherein individual waveguides of the one or more waveguides of the optical interposer are aligned to individual waveguides of the one or more waveguides of the PIC die;
mechanical adhesive securing the optical interposer to the PIC die; and
index-matching material between the one or more waveguides of the PIC die and the one or more waveguides of the optical interposer, wherein the mechanical adhesive is different from the index-matching material.

2. The apparatus of claim 1, wherein the mechanical adhesive comprises monodisperse particles suspended in the mechanical adhesive.

3. The apparatus of claim 1, wherein a coefficient of thermal expansion (CTE) of the mechanical adhesive is less than 10⁻⁵ K⁻¹, wherein a CTE of the index-matching material is more than 2×10⁻⁵ K⁻¹.

4. The apparatus of claim 1, wherein the mechanical adhesive is thermally cured, wherein the index-matching material is ultraviolet-light cured.

5. The apparatus of claim 1, wherein the optical interposer comprises one or more V-grooves defined in a surface of the optical interposer, wherein the PIC die comprises one or more V-grooves defined in a surface of the PIC die, wherein the one or more V-grooves of the PIC die are mated with the one or more V-grooves of the optical interposer, wherein at least part of the mechanical adhesive is positioned between the one or more V-grooves of the PIC die and the one or more V-grooves of the optical interposer.

6. The apparatus of claim 5, wherein the optical interposer further comprises wings that extend from an area of the optical interposer with the one or more V-grooves to sides of the optical interposer, wherein at least part of the mechanical adhesive is positioned between the wings and a surface of the PIC die.

7. The apparatus of claim 6, wherein the optical interposer extends past an edge of the PIC die, wherein a side wall of the optical interposer extends below a plane defined by the surface of the PIC die, wherein at least part of the mechanical adhesive is positioned between the side wall of the optical interposer and a side wall of the PIC die.

8. The apparatus of claim 5, wherein one or more trenches are defined in the PIC die between the one or more waveguides of the PIC die and the one or more V-grooves of the PIC die, wherein the index-matching material at least partially fills the one or more trenches.

9. The apparatus of claim 5, wherein the PIC die comprises one or more additional V-grooves defined in the surface of the PIC die, wherein the one or more additional V-grooves of the PIC die are mated with the one or more V-grooves of the optical interposer, wherein a trench is defined in the PIC die between the one or more V-grooves of the PIC die and the one or more additional V-grooves of the PIC die.

10. The apparatus of claim 9, wherein more than half of the trench is filled with the mechanical adhesive.

11. The apparatus of claim 9, wherein more than half of the trench is filled with the index-matching material.

12. The apparatus of claim 5, wherein a trench is defined in the PIC die between the one or more V-grooves of the PIC die and a wall at a side surface of the PIC die, wherein the mechanical adhesive fills at least part of the trench.

13. An integrated circuit package comprising the apparatus of claim 1, further comprising one or more electronic integrated circuit (EIC) dies, wherein the one or more EIC dies are electrically coupled to the PIC die.

14. An apparatus comprising:
a photonic integrated circuit (PIC) die comprising:
one or more waveguides;
one or more V-grooves defined in a surface of the PIC die, the one or more V-grooves of the PIC die comprising one or more peaks and one or more valleys; and
an optical interposer mated with the PIC die, the optical interposer comprising:
one or more waveguides, wherein individual waveguides of the one or more waveguides of the optical interposer are aligned to individual waveguides of the one or more waveguides of the PIC die; and
one or more V-grooves defined in a surface of the optical interposer, the one or more V-grooves of the optical interposer comprising one or more peaks and one or more valleys,
wherein individual peaks of the one or more peaks of the one or more V-grooves of the PIC die mate with individual valleys of the one or more valleys of the one or more V-grooves of the optical interposer.

15. The apparatus of claim 14, wherein sidewalls of individual V-grooves of the one or more V-groves of the optical interposer do not apply stress to sidewalls of individual V-grooves of the one or more V-groves of the PIC die.

16. The apparatus of claim 14, wherein a trench is defined in the PIC die between the one or more V-grooves of the PIC die and a wall at a side surface of the PIC die, wherein mechanical adhesive fills at least part of the trench.

17. The apparatus of claim 14, further comprising:
mechanical adhesive securing the optical interposer to the PIC die; and
index-matching material between the one or more waveguides of the PIC die and the one or more waveguides of the optical interposer, wherein the mechanical adhesive is different from the index-matching material.

18. A method comprising:
positioning an optical interposer on a photonic integrated circuit (PIC) die, wherein the optical interposer comprises one or more waveguides, wherein the PIC die comprises one or more waveguides, wherein the optical interposer is positioned such that individual waveguides of the one or more waveguides of the optical interposer are aligned to individual waveguides of the one or more waveguides of the PIC die, wherein index-matching material is positioned between the one or more waveguides of the PIC die and the one or more waveguides of the optical interposer, wherein mechanical adhesive is positioned between at least part of the optical interposer and at least part of the PIC die;
thermally curing the mechanical adhesive without curing the index-matching material; and
curing the index-matching material using ultraviolet light after thermally curing the mechanical adhesive.

19. The method of claim 18, wherein the PIC die comprises a wall at a side surface of the PIC die, wherein the wall forms part of a trench defined in the PIC die, wherein the wall prevents at least one of the mechanical adhesive and the index-matching material from leaking down the side surface of the PIC die before being cured.

20. The method of claim 18, wherein the mechanical adhesive has a viscosity more than 10,000 centipoise before curing, wherein the index-matching material has a viscosity less than 1,000 centipoise before curing.
